(19) United States
(12) Patent Application Publication
(10) Pub. No.: US 2010/0304985 A1
(43) Pub. Date: Dec. 2, 2010

(54) METHODS AND COMPOSITIONS FOR DETERMINING WHETHER A SUBJECT CARRIES A DISEASE ASSOCIATED GENE MUTATION COMMON IN JEWISH POPULATIONS

(75) Inventors: Iris Schrijver, Woodside, CA (US); Phyllis Gardner, Stanford, CA (US); Eugene Pergament, Chicago, IL (US); Morry Fiddler, Chicago, IL (US)

Correspondence Address: BOZICEVIC, FIELD & FRANCIS LLP, 1900 UNIVERSITY AVENUE, SUITE 200, EAST PALO ALTO, CA, 94303, US

(73) Assignee: THE BOARD OF TRUSTEES OF THE LELAND STANFORD JUNIOR UNIVERSITY, Palo Alto, CA (US)

(21) Appl. No.: 11/916,439

(22) PCT Filed: Oct. 25, 2007
(86) PCT No.: PCT/US07/22666

§ 371 Date: Aug. 11, 2010

Related U.S. Application Data
(60) Provisional application No. 60/854,575, filed on Oct. 25, 2006.
(60) Provisional application No. 60/855,893, filed on Oct. 31, 2006.

(51) Int. Cl. C40B 30/04; C40B 40/06

(52) U.S. Cl. 506/9; 506/16

(57) ABSTRACT

Methods are provided for determining whether a subject carries a disease associated gene mutation common in Jewish populations. In practicing the subject methods, an array comprising a plurality of associated gene mutation probes is contacted with a nucleic acid sample from the subject, and the presence of any resultant surface bound target nucleic acids is detected to determine whether the subject carries an disease associated gene mutation common in Jewish populations. In addition, reagents and kits thereof that find use in practicing the subject methods are provided.

### BACKGROUND

The contemporary Jewish population is subdivided into three discrete groups based on their long-term location of residence: Middle Eastern (also known as Oriental) Jews, Sephardic Jews and Ashkenazi Jews (AJ). The latter group, which inhabited northern and eastern Europe since the 9th century C.E., accounts for ˜90% of the 5.7 million Jews living in the U.S. today. This Jewish community has remained distinct as a result of cultural factors such as religion, customs, and language. Concomitantly, a set of genetic disorders relatively specific to the AJ people, has emerged for unknown reasons but for which hypotheses and speculations have ranged from random drift to selective advantages. One or a small set of founder mutations, which account for almost all of the mutations in this population, characterizes each of these conditions.

The American College of Obstetricians and Gynecologists (AGOG) currently recommends AJ population-based carrier screening for four inherited disorders: Tay-Sachs disease, Cystic Fibrosis, Canavan Disease, and Familial Dysautonomia, based on carrier frequencies of 1:40 or less. However, several additional disorders are prevalent in this ethnic group and most of these are severely disabling or fatal. Most commonly, current genetic testing is performed for a sub-set of the disorders only, or sequentially.

### SUMMARY OF THE INVENTION

Methods are provided for determining whether a subject carries a disease associated gene mutation common in Jewish populations. In practicing the subject methods, an array comprising a plurality of associated gene mutation probes is contacted with a nucleic acid sample from the subject, and the presence of any resultant surface bound target nucleic acids is detected to determine whether the subject carries an disease associated gene mutation common in Jewish populations. In addition, reagents and kits thereof that find use in practicing the subject methods are provided.

### BRIEF DESCRIPTION OF THE FIGURES

FIG. 1: APEX analysis for sequence variant 2281del6ins7 (735delATCTGAinsTAGATTC) in the BLM gene. Each numbered row represents the analysis of an individual patient sample. The row presents two sets of four-channel fluorescent images representing the bases adenine (A), cytosine (C), guanine (G), and thymine (T), respectively, for the sense strand (upper) and antisense strand (lower). The histograms to the right of the fluorescent images are of the fluorescent intensities of the four channels at the mutation analysis site. The letters to the right of the histogram represent the base(s) identified on each strand. Row 1 contains the results of heterozygous target DNA from an individual with genotype WT/2281de16ins7. In this case, the sense strand is extended by both the WT base A and base T, complementary for the mutation. The oligo that interrogates the mutation from the opposite direction demonstrates presence of a T (WT) and a G, the expected signal in a mutation carrier. This illustrates the separate primers used for deletions/insertions. Row 2 contains the results of normal DNA (WT/WT), in which the sense strand is extended by the WT base A and the anti-sense strand is extended by the WT base T. Row 3 is a negative control.

FIG. 2: APEX analysis for sequence variant R696P in the IKBKAP gene. The results are presented as described in FIG. 1. Row 1 contains the results of normal DNA (WT/WT), in which the sense strand is extended by the WT base G and the anti-sense strand is extended by the WT base C. Row 2 contains the results of heterozygous target DNA from a carrier (WT/R696P). In this case, the sense strand is extended by the WT base G and base C complementary for the mutation. The antisense strand is extended by the WT base C and base G, complementary for the mutation. Row 3 is a negative control.

### DETAILED DESCRIPTION

Methods are provided for determining whether a subject carries a disease associated gene mutation common in Jewish populations. In practicing the subject methods, an array comprising a plurality of associated gene mutation probes is contacted with a nucleic acid sample from the subject, and the presence of any resultant surface bound target nucleic acids is detected to determine whether the subject carries an disease associated gene mutation common in Jewish populations. In addition, reagents and kits thereof that find use in practicing the subject methods are provided.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As summarized above, the subject invention is directed to methods of determining whether a subject carries a disease associated gene mutation common in Jewish populations, as well as compositions of matter and kits thereof that find use in practicing the subject methods. In further describing the invention, the subject methods are described first in greater detail, followed by a review of representative applications in which the methods find use, as well as reagents and kits that find use in practicing the subject methods.

### Methods

The subject invention provides methods of determining whether a patient or subject carries a disease associated gene mutation common in Jewish populations, such as Ashkenazi and Sephardic Jewish populations. By “disease associated gene mutation” is meant that the gene mutation has been linked or associated with disease condition, i.e., the gene mutation has been observed in patients that have a particular disease and is positively correlated with the presence of disease in the patient. By “carries” is meant that a subject has a disease associate gene mutation, where the subject may be heterozygous or homozygous for the particular mutation and be considered to carry the mutation. Representative genes associated with disease conditions common in Jewish populations include, but are not limited to, those listed in Table 1 in the Experimental Section, below. The disease associated gene mutations that may be detected according to the subject invention may be deletion mutations, insertion mutations or point mutations, including substitution mutations.

In practicing the methods of the subject invention, a host or subject is simultaneously screened for the presence of a plurality of different disease associated gene mutations. In certain embodiments, the host or subject is simultaneously screened for the presence of at least 25 different mutations, such as at least about 40 different gene mutations and including at least about 50 different gene mutations. In certain other embodiments the number of different gene mutations that are simultaneously screened is about 50 or more, such as about 100, or more, including about 150 or more. In certain embodiments, the disease associated gene mutations that are screened are from two or more different disease associate genes, e.g., about 3 or more, about 4 or more, about 5 or more, about 10 or more, about 15 or more, about 25 or more, etc. In certain embodiments, the disease associated gene mutations that are screened or assayed in a given test include about 25 or more of the mutations listed in Table 1, such as about 50 or more of the mutations listed in Table 1, including all, of the mutations listed in Table 1.

In certain embodiments of the present invention, the host may be simultaneously screened for the presence of a plurality of disease associated gene mutations using any convenient protocol, so long as about 25 or more, such as about 50 or more, of the mutations appearing in Table 1 are assayed. In such embodiments, protocols for screening a host for the presence of the disease associated gene mutations include, but are not limited to, array-based protocols, including those described in U.S. Pat. Nos. 6,027,880 and 5,981,178, the disclosures of which are herein incorporated by reference.

In certain embodiments of interest, in addition to the disease associate gene mutations of Table 1, the sample is assayed for the presence of 1 or more, such as 2 or more, 5 or more, 10 or more, 20 or more Cystic Fibrosis Transmembrane Conductance Regulator (CFTR) gene mutations, where mutations of interest include, but are not limited to, those disclosed in U.S. patent application Ser. No. 10/888,435; the disclosure of which is herein incorporated by reference. Specific CFTR gene mutations of interest include, but are not limited to: ΔF508, ΔI507, G542X, G551D, W1282X, N1303K, R553X, 621+1G>T, R117H, 1717-1G>A, A455E, R560T, R1162X, G85E, R334W, R347P, 711+1G>T, 1898+1G>A, 2184delA, 3849+10 kbC>T, 2789+5G>A, 3659delC, 3120+1G>A. See Table 5 for a listing of oligonucleotides that find use in the present invention for identifying CFTR gene mutations.

In certain embodiments of interest, an arrayed primer extension assay protocol (e.g., as described in Kurg et al., Genet. Test (2000) 4:1-7 and Tonisson et al., Microarray Biochip Technology (ed. Schena, Eaton Publishing, Natick Mass.) (2000) pp. 247-263) is employed to screen a subject for the presence of a plurality of different disease associated gene mutations. In such embodiments, an array of a plurality of distinct disease associated gene mutation specific probes is first contacted with a nucleic acid sample from the host or subject. The resultant sample-contacted array is then subjected to primer extension reaction conditions in the presence of two or more, including four, distinguishably labeled dideoxynucleotides. The resultant surface bound labeled extended primers are then detected to determine the presence of at least one disease associated gene mutation in the host or subject from which the sample was obtained. Each of these steps is now described in greater detail below.

As summarized above, the first step of the protocol employed in these embodiments is to contact an array of a plurality of disease associated gene mutation probes with a nucleic acid sample from the host or subject being screened. The array employed in these embodiments includes a plurality of disease associated gene mutation probes immobilized on a surface of a solid substrate, where each given probe of the plurality is immobilized on the substrate surface at a known location, such that the location of a given probe can be used to identify the sequence or identity of that probe. Each given probe of the plurality is typically a single stranded nucleic acid, having a length of from about 10 to about 100 nt, including from about 15 to about 50 nt, e.g., from about 20 to about 30 nt, such as 25 nt. The arrays employed in the subject methods may vary with respect to configuration, e.g., shape of the substrate, composition of the substrate, arrangement of probes across the surface of the substrate, etc., as is known in the art. Numerous array configurations are known to those of skill in the art, and may be employed in the subject invention. Representative array configurations of interest include, but are not limited to, those described in U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992; the disclosures of which are herein incorporated by reference; as well as WO 95/21265; WO 96/31622; WO 97/10365; WO 97/27317; EP 373 203; and EP 785 280.

As mentioned above, aspects of the arrays employed in this embodiment of the invention is that they include a plurality of different disease associated gene mutation probes. The total number of disease associated gene mutation probes that may be present on the surface of the array, i.e., the total number of disease associated gene mutations that may be represented on the array, may vary, but is in certain embodiments about 25 or more, such as about 40 or more and including about 50 or more different gene mutations. In certain embodiments, the disease associated gene mutations that are represented on the array in the form of probes include at about 25 or more of the mutations listed in Table 1, such as about 50 or more of the mutations listed in Table 1, including of all of the mutations listed in Table 1. In certain embodiments, the arrays employed in the subject methods include a pair of different probes for each given disease-associated gene mutation represented on the array. In certain of these embodiments, the pair of probes corresponds to the sense and antisense strand of the disease associated gene region that includes the mutation of interest (e.g., as described in Kurg et al., Genet. Test (2000) 4:1-7).

As summarized above, the first step in the subject methods is to contact a nucleic acid sample obtained from the host or subject being screened with the array to produce a sample contacted array. The nucleic acid sample is, in certain embodiments, one that contains an amplified amount of fragmented disease associated gene nucleic acids, e.g., DNA or RNA, where in certain other embodiments the nucleic acid sample is a DNA sample. The nucleic acid sample may be prepared from one or more cells or tissue harvested from a subject to be screened using standard protocols. Following harvesting of the initial nucleic acid sample, the sample is subjected to conditions that produce amplified amounts of one or more of the disease associated genes present in the sample which are to be probed on the array. While any convenient protocol may be employed, in certain embodiments the sample is contacted with a pair of primers that flank each region of interest of the disease associated gene, i.e., a pair of primers for each region of interest of each of the disease associated genes to be assayed, and then subjected to PCR conditions. This step results in the production of an amplified amount of nucleic acid for each particular region or location of the one or more disease associated genes of interest. Amplification protocols that find use in such methods are well known to those of skill in the art.

The resultant nucleic acid composition that includes an amplified amount of the disease associated gene sequences is then fragmented to produce a fragmented disease associated gene sample. Fragmentation may be accomplished using any convenient protocol, where representative protocols of interest include both physical (e.g., shearing) and enzymatic protocols. In certain embodiments, an enzymatic fragmentation protocol is employed, where the nucleic acid sample is contacted with one or more restriction endonucleases that cleave the one or more disease associated gene nucleic acids into two or more fragments.

The resultant amplified fragmented disease associated gene nucleic acid sample is then contacted with the array under conditions sufficient to produce surface immobilized duplex nucleic acids between host or subject derived nucleic acids and any complementary probes present on the surface of the array. In certain embodiments, the sample is contacted with the array under stringent hybridization conditions. The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions sets forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Put another way, stringent hybridization conditions are hybridization conditions that are at least as stringent as the above representative conditions, where conditions are considered to be at least as stringent if they are at least about 80% as stringent, typically at least about 90% as stringent as the above specific stringent conditions. Other stringent hybridization conditions are known in the art and may also be employed, as appropriate.

Sample contact and washing of the array as described above results in the production of a sample contacted array, where the sample contacted array is characterized by the presence of surface bound duplex nucleic acids, generally at each position of the array where probe nucleic acids and target nucleic acids in the sample have sufficiently complementary sequences to hybridize with each other into duplex nucleic acids under the conditions of contact, e.g., stringent hybridization conditions.

Following production of the sample contacted array, as described above, the presence of any disease associated gene mutations in the assayed nucleic acid sample, and therefore the host genome from which the sample was prepared, is detected. Depending on the nature of the array employed and the detection protocol used, a number of different protocols may be employed for determining the presence of one or more disease associated gene mutations in the assayed nucleic acid sample. For example, in certain embodiments in which the array includes immobilized probes that specifically bind only to target nucleic acids generated from mutated genomic sequences, detection of surface bound duplex nucleic acids can be used directly to determine the presence of one or more disease associated gene mutations in the sample.

In certain embodiments, the presence of any disease associated gene mutations is detected using a primer extension protocol, in which the surface bound probe component of the duplex nucleic acid acts as a primer which is extended in a template dependent primer extension reaction using the hybridized complement of the probe which is obtained from the patient derived nucleic acid sample as a template. In these embodiments, the sample-contacted array is contacted with primer extension reagents and maintained under primer extension conditions.

Primer extension reactions are well known to those of skill in the art. In this step of the subject methods, the sample-contacted array is contacted with a DNA polymerase under primer extension conditions sufficient to produce the desired primer extension molecules. DNA polymerases of interest include, but are not limited to, polymerases derived from E. coli, thermophilic bacteria, archaebacteria, phage, yeasts, Neurosporas, Drosophilas, primates and rodents. The DNA polymerase extends the probe “primer” according to the template to which it is hybridized in the presence of additional reagents which may include, but are not limited to: dNTPs; monovalent and divalent cations, e.g. KCl, MgCl₂; sulfhydryl reagents, e.g. dithiothreitol; and buffering agents, e.g. Tris-Cl.

In certain embodiments, the primer extension reaction of this step of the subject methods is carried out in the presence of at least two distinguishably labeled dideoxynucleotide triphosphates, or ddNTPs. In certain of these embodiments, the primer extension reaction of this step of the subject methods is carried out in the presence of at least four distinguishably labeled dideoxynucleotide triphosphates (ddNTPs), e.g., ddATP, ddCTP, ddGTP and ddTTP, and in the absence of deoxynucleotide triphosphates (dNTPs).

Extension products that are produced as described above are typically labeled in the present methods. As such, the reagents employed in the subject primer extension reactions typically include a labeling reagent, where the labeling reagent is typically a labeled nucleotide, which may be labeled with a directly or indirectly detectable label. A directly detectable label is one that can be directly detected without the use of additional reagents, while an indirectly detectable label is one that is detectable by employing one or more additional reagents, e.g., where the label is a member of a signal producing system made up of two or more components. In certain embodiments, the label is a directly detectable label, such as a fluorescent label, where the labeling reagent employed in such embodiments is a fluorescently tagged nucleotide(s), e.g., ddCTP. Fluorescent moieties which may be used to tag nucleotides for producing labeled probe nucleic acids include, but are not limited to: fluorescein, the cyanine dyes, such as Cy3, Cy5, Alexa 555, Bodipy 630/650, and the like. Other labels may also be employed as are known in the art.

In the primer extension reactions employed in the subject methods of these embodiments, the surface of the sample contacted array is maintained in a reaction mixture that includes the above-discussed reagents at a sufficient temperature and for a sufficient period of time to produce the desired labeled probe “primer” extension products. Typically, this incubation temperature ranges from about 20° C. to about 75° C., usually from about 37° C. to about 65° C. The incubation time typically ranges from about 5 min to about 18 hr, usually from about 1 hr to about 12 hr.

Primer extension of any duplexes on the surface of the array substrate as described above results, in certain embodiments, in the production of labeled primer extension products. In those embodiments where primer extension is carried out solely in the presence of distinguishably labeled ddNTPs, as described above, the primer extension reaction results in extension of the probe “templates” by one labeled nucleotide only.

Following production of labeled primer extension products, as described above, the presence of any labeled products is then detected, either qualitatively or quantitatively. Any convenient detection protocol may be employed, where the particular protocol that is used will necessarily depend on the particular array assay, e.g., the nature of the label employed. Representative detection protocols of interest include, but are not limited to, those described in U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992; the disclosures of which are herein incorporated by reference; as well as WO 95/21265; WO 96/31622; WO 97/10365; WO 97/27317; EP 373 203; and EP 785 280.

Where the primer extension products are fluorescently labeled primer extension products, any convenient fluorescently labeled primer extension protocol may be employed. In certain embodiments, a “scanner” is employed that is capable of scanning a surface of an array to detect the presence of labeled nucleic acids thereon. Representative scanner devices include, but are not limited to, those described in U.S. Pat. Nos. 5,585,639; 5,760,951; 5,763,870; 6,084,991; 6,222,664; 6,284,465; 6,329,196; 6,371,370 and 6,406,849. In certain embodiments, the scanner employed is one that is capable of scanning an array for the presence of four different fluorescent labels, e.g., a four-channel scanner, such as the one disclosed in published U.S. Patent Application Serial No. 20010003043; the disclosure of which is herein incorporated by reference.

The final step in these embodiments of the subject methods is to determine the presence of any disease associated gene mutations in the assayed sample, and therefore the host from which the sample was obtained, based on the results of the above surface immobilized duplex nucleic acid detection step. In this step of the subject methods, any detected labeled duplex nucleic acids, and specifically labeled extended primers, are employed to determine the presence of one or more disease associated gene mutations in the host from which the screened sample was obtained. This step is practiced by simply identifying the location on the array of the labeled duplex, and then identifying the probe(s) (and typically sequence thereof) of the probe “primer” at that location which was extended and labeled. Identification of the probe(s) provides the specific disease associated gene mutation(s) that is present in the host from which the sample was obtained.

Using the above described protocols, the presence of one or more disease associated gene mutations in the genome of a given subject or host may be determined. In other words, whether or not a host carries one or more disease associated gene mutations may be determined using the subject methods. The subject methods may be employed to determine whether a host is homozygous or heterozygous for one or more disease associate gene mutations. A feature of the subject methods is that they provide for a highly sensitive assay for the presence of disease associated gene mutations across a broad population. For example, they provide for a sensitivity of at about 60% or higher, including about 65% or higher, about 70% or higher, about 75% or higher, e.g., about 80% or higher, about 85% or higher, about 90% or higher, in a plurality of different racial backgrounds, including Caucasian, Asian, Hispanic and African racial backgrounds.

In certain embodiments, the methods of the present application are used to detect the presence of one or more disease associated gene mutations in multiple subjects with a high degree of accuracy. By high degree of accuracy is meant that about 90% or more of the disease associated gene mutations present in the samples are accurately identified using the methods of the invention, including accuracies of about 92% or greater, about 95% or greater, about 97% or greater, about 99% or greater and up to an accuracy of 100%. In these embodiments, multiple samples from different subjects are be processed according to the methods of the present invention with a single APEX array being used for each individual subject's sample (e.g., in a high throughput fashion). The number of distinct samples processed in these embodiments may vary widely, including, but not limited to, 2 samples or more, 5 samples or more, 20 samples or more or up to 100 samples or more, where the multiple samples are all evaluated with the high degree of accuracy, as reviewed above. In general, the limitation in the number of samples that can be processed at a time is based on the resources of one employing the methods of the present invention. As such, no limitation in this regard is intended.

### Utility

The subject methods find use in a variety of different applications. In certain embodiments, the above-obtained information is employed to diagnose a host, subject or patient with respect to whether or not they carry a particular disease associated gene mutation common in Jewish populations, such as Ashkenazi and Sephardic Jewish populations.

In certain other embodiments, the subject methods are employed to screen potential parents to determine whether they risk producing offspring that are homozygous for one or more disease associated mutations. In other words, the subject methods find use in genetic counseling applications, where prospective parents can be screened to determine their potential risk in producing a child that is homozygous for a disease associated gene mutation (or heterozygous for two disease causing mutations) and will suffer from a disease associated therewith, e.g., hearing loss.

In certain other embodiments, the subject methods and compositions are employed to screen populations of individuals, e.g., to determine frequency of various mutations. For example, a select population of individuals, e.g., grouped together based on race, geographic region, etc., may be screened according to the subject invention to identify those mutations that appear in members of the population and/or determine the frequency at which such identified mutations appear in the population.

### Reagents and Kits

Also provided are reagents and kits thereof for practicing one or more of the above-described methods. The subject reagents and kits thereof may vary greatly depending on the particular embodiment of the invention to be practiced. Reagents of interest include, but are not limited to: nucleic acid arrays (as described above); disease associated gene specific primers, e.g., for using in nucleic acid sample preparation, as described above, one or more uniquely labeled ddNTPs, DNA polymerases, various buffer mediums, e.g. hybridization and washing buffers, and the like.

In addition to the above components, the subject kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Yet another means would be a computer readable medium, e.g., diskette, CD, etc., on which the information has been recorded. Yet another means that may be present is a website address which may be used via the internet to access the information at a removed site. Any convenient means may be present in the kits.

The following examples are offered by way of illustration and not by way of limitation.

### EXPERIMENTAL

### I. Materials and Methods

### A. Mutation Selection

The full set of mutations and pseudodeficiency alleles is listed in Table 1, below. The 59 variants on the APEX microarray were selected from the literature (Table 1), as well as the Online Mendelian Inheritance in Man (OMIM), (www(dot)ncbi(dot)nlm(dot)nih(dot)gov/Omim) and Genetests (www(dot)genetests(dot)org) databases. The selected mutations represent the most frequently identified mutations in Ashkenazi Jews. In addition to pathogenic mutations for this population, we also included two pseudo-alleles in the HEXA gene and several mutations which are associated with the conditions in our panel, but are not exclusive to Ashkenazi Jews (Table 1) to extend the diagnostic capacity of the microarray.

TABLE 1
Complete list of mutations detectable with the AJ APEX assay.

| Disease | Gene | Mutations | Car. fr | Mut. Det. |
|---|---|---|---|---|
| Bloom | BLM | 736delATCTGAinsTAGATTC | ~1:102 | >97% |
| syndrome | | (2281del6/ins7) (from start codon 2206del6/ins7) | | |
| Canavan | ASPA | Y231X (693C > A) | ~1:40 | >99% |
| | | E285A (854A > C) | | |
| | | A305E (914C > A) | | |
| | | IVS2-2A > G | | |
| Factor XI | F11 | IVS14 + 1G > A | ~1:23 | >96% |
| deficiency | | E117X (576 G > T) (from start codon: | | |
| | | E135X; 403G > T) | | |
| | | F283L (1074 A > C) (from start codon: | | |
| | | F301L; 901T > C) | | |
| Familial | IKBKAP | IVS20 + 6T > C | ~1:30 | >99% |
| Dysautonomia | | R696P (2397G > C) (from start codon: | | |
| | | 2087G > C) | | |
| Familial | MEFV | Exon 2: | ~1:5 | ~90% |
| mediterranean | | E148Q (442 G > C) | | |
| fever | | *E167D (501 G > C) | | |
| | | T267I (800 C > T) | | |
| | | Exon 3: | | |
| | | P369S (1105 C > T) | | |
| | | R408Q (1223 G > A) | | |
| | | Exon 5: | | |
| | | F479L (1437 C > G) | | |
| | | Exon 10: | | |
| | | R653H (1958 G > A) | | |
| | | M680I (2040 G > C) | | |
| | | ΔI 692 (del2076-2078) | | |
| | | M694V (2080 A > G) | | |
| | | M694I (2082 G > A) | | |
| | | K695R (2084 A > G) | | |
| | | V726A (2177 T > C) | | |
| | | A744S (2230 G > T) | | |
| | | R761H (2282 G > A) | | |
| Fanconi | FANCC | IVS4 + 4A > T (711 + 4A > T) | ~1:80 | >99% |
| Anemia | | R548X^{NE and AJ} (1642C > T) | | |
| | | 322delG^{NE and AJ} (from start codon 67delG) | | |
| | | Q13X^{SI} (37C > T) | | |
| Gaucher | GBA | 84insG (from start codon 94insG) | ~1:10 | >90% |
| Disease | | N370S (1226 A > G) (from start codon | | |
| | | N409S) | | |
| | | V394L^{NJ} (1307 G > T) (from start codon | | |
| | | V433L; 1297G > T) | | |
| | | *L444P (1448 T > C) (from start codon | | |
| | | L483P) | | |
| | | IVS2 + 1G > A | | |
| | | R496H^{NJ} (1604 G > A) (from start codon | | |
| | | R535H) | | |
| | | *1035insG^{NJ} | | |
| Glycogen | G6PC | R83C (326C > T) (from start codon R82C; | ~1:71 | ~94% |
| Storage | | 247C > T) | | |
| Disease la | | | | |
| (von Gierke) | | | | |
| Glycogen | AGL | 1484delT (4455delT) | ~1:35^{NAJ} | ?All N. |
| storage | | | | African |
| disease type | | | | Jews in |
| IIIa (N. African | | | | Israel? |
| Jews) | | | | |
| Maple Syrup | BCKHDB | R183P (548 G > C) | ~1:80 | ~99% |
| Urine Disease | | G278S (832G > A) | | |
| | | E372X (1114G > T) | | |
| Mucolipidosis | MCOLN1 | IVS3-2A > G | ~1:100 | >95% |
| type IV | | delE1-E7 (511del6944) | | |
| Niemann Pick | SMPD1 | L302P (905T > C) (from start codon L337P | ~1:80 | ~95% |
| type A | | 1010T > C) | | |
| | | fsP330 (delC) (from start codon P365delC) | | |
| | | R496L (1487G > T) (from start codon | | |
| | | R1667L) 1592G > T) | | |
| | | *ΔR608 (from start codon R643) | | |
| Nonsyndromic | GJB2 | 35delG | ~1:25 | >60% |
| sensorineural | | *167delT | | |
| hearing loss | | | | |
| Tay Sachs | HEXA | G269S (805G > A) | ~1:28 | >93% |
| | | 1278insTATC | | |
| | | IVS12 + 1G > C | | |
| | | IVS9 + 1G > A | | |
| | | R249W (745C > T)^{P} | | |
| | | R247W (739C > T)^{P} | | |
| | | IVS7 + 1G > A^{FRC} | | |
| | | *Δ7.6kb^{FRC} | | |
| Torsion | DYT1 | ΔE302 | ~1:900 | >95% |
| dystonia | | ΔF323-Y328 | | |

Car. fr. = Carrier frequency;
Mut. Det. = Mutation detection with carrier screening;
P = pseudodeficiency allele;
FRC = French Canadian;
NE = Northern European;
AJ = Ashkenazi Jewish;
SI = Southern Italian;
NJ = Not Jewish specific;
NAJ = North African Jews.
Customary as well as conventional (counting from the A in the ATG start codon) amino acid and nucleotide numbering are used in the table, where the two are discrepant.
Asterisk: indicates that a mutation is detected reliably in one direction only.

### B. Oligonucleotide Microchips

Oligonucleotide primers were designed according to the wild-type gene sequences for both the forward and reverse directions. The oligonucleotides were each 25 basepair (bp) in length and carried 5-prime 6-carbon amino linkers (MWG, Munich, Germany). Typically, these oligonucleotides were designed to specifically identify one by in the sequence. For deletions and insertions with the same nucleotide one by downstream, the oligo was designed so that it extended further into the deletion or insertion for optimal discrimination.

The microarray slides used for spotting the oligonucleotides were created as described previously (Schrijver I, Oitmaa E, Metspalu A, Gardner P: “Genotyping microarray for the detection of more than 200 CFTR mutations in ethnically diverse populations,” J. Mol. Diagn. 2005, 7:375-387). For each mutation under interrogation, two forward and two reverse strand oligonucleotides were spotted, for a total of four datapoints per possible sequence variant. In order to reduce the background fluorescence and to avoid re-hybridization of unbound oligonucleotides to the APEX slide, the slides were washed with 95° C. distilled water and 100 mM NaOH, prior to the APEX reactions.

### C. Genomic and Synthetic Templates and Preparation

Where possible, native genomic DNA was collected from blood and cell culture samples using standard, commercially available DNA purification procedures. DNA (>100 ng/sample) from 23 patient or cell line samples with known mutations were evaluated on the chip (Table 2).

TABLE 2
Genomic DNA samples used for mutation evaluation
on the AJ APEX array.

| Gene | Mutations validated with gDNA |
|---|---|
| MCOLN1 | IVS3-2A > G |
| MCOLN1 | Del E1-E7 |
| SMPD1 | L302P (from start codon L337P |
| SMPD1 | fsP330 (from start codon P365delC) |
| SMPD1 | R496L (from start codon R1667L) |
| G6PC | R83C (from start codon R82C) |
| BLM | 2281del6/ins7 (from start codon 2206del6/ins7) |
| HEXA | G269S |
| HEXA | 1278insTATC |
| HEXA | IVS12 + 1G > C |
| ASPA | Y231X |
| ASPA | E285A |
| FANCC | IVS4 + 4A > T |
| IKBKAP | R696P |
| IKBKAP | IVS20 + 6T > C |
| GBA | 84 insG (from start codon 94insG) |
| GBA | IVS2 + 1G > A |
| GBA | N370S (from start codon N409S) |
| GBA | R496H (from start codon R535H) |

The presence of mutations in commercially available samples (Coriell Cell repositories, http(colon)//locus(dot)umdnj(dot)edu/ccr) was verified in the Molecular Pathology laboratory at Stanford Hospital and Clinics. Blood samples were obtained from individuals who had been seen for genetic counseling and had also been identified as heterozygous for one or more of the mutations in the APEX array by a commercial laboratory. These carriers provided informed consent for research use of their DNA, obtained from venous blood samples. This set of samples was de-identified. Where native genomic DNA samples containing the screened mutations were unavailable, synthetic templates of approximately 50 by in length were designed according to the variant sequence. Templates were created for both the sense and antisense directions and optimized for melting temperature.

For template preparation, the genes were amplified from genomic DNA in 37 amplicons. The PCR reaction mixture (15 μL) was optimized with the following: 10× Taq DNA polymerase buffer; 2.5 mM MgCl₂ (Naxo, Estonia); 0.25 mM dNTP (MBI Fermentas, Vilnius, Lithuania) (20% fraction of dTTP was substituted with dUTP), 10 pmol primer stock, genomic DNA (approximately 25 ng), SMART-Taq Hot DNA polymerase (1.5 U) (Naxo, Estonia), and sterile deionized water. After amplification (MJ Research DNA Thermal Cycler; MJ Research, Inc., Waltham, Mass.), the amplification products were concentrated and purified using Jetquick spin columns (Genomed GmbH, Lohne, Germany). In a one-step reaction the functional inactivation of the traces of unincorporated dNTPs was achieved by addition of shrimp Alkaline Phosphatase (Amersham Pharmacia Biotech, Inc., Milwaukee, Wis.) and fragmentation of the PCR product was accomplished by addition of thermolabile Uracil N-Glycosylase (Epicenter Technologies, Madison, Wis.) followed by heat treatment (Kurg, A. et al., Genet Test 2000, 4:1-7).

### D. Arrayed Primer Extension (APEX) Reactions:

The APEX mixture consisted of 32 μL fragmented product, 4U of Thermo Sequenase DNA polymerase (Amersham Pharmacia Biotech, Inc., Milwaukee, Wis.), 4 μL Thermo Sequenase reaction buffer (260 mM Tris-HCl, pH 9.5, 65 mM MgCl₂) (Amersham Pharmacia Biotech, Inc., Milwaukee, Wis.) and 1 μM final concentration of each fluorescently-labeled ddNTP-s: Cy5-ddUTP, Cy3-ddCTP, Texas Red-ddATP, Fluorescein-ddGTP, (PerkinElmer Life Sciences, Wellesley, Mass.). The DNA was first denatured at 95° C. for ten minutes. The enzyme and the dyes were immediately added to the DNA mixture, and the whole mixture was applied to pre-warmed slides. The reaction was allowed to proceed for 20 minutes at 58° C., followed by washing once with 0.3% Alconox (Alconox, Inc.) and twice for 90 sec at 95° C. with distilled water (TKA, Germany). A droplet of antibleaching reagent (AntiFade SlowFade, Molecular Probes Europe BV, Leiden, The Netherlands) was applied to the slides before imaging.

### E. Datapoints:

The APEX array for Jewish disorders has a redundancy of datapoints to assure optimal sensitivity and specificity of the assay. For each mutation, four points are available for data analysis because both the forward and reverse primers are spotted in duplicate. This markedly reduces non-specific signals which could lead to false-positive interpretation, and enables easy differentiation between homozygous and heterozygous samples. The array images were captured by means of detector GENORAMA™ Quattrolmager 003 (Asper Biotech Ltd, Tartu, Estonia) at 20 μm resolution. This detection instrument combines a total internal reflection fluorescence (TIRF) based excitation mechanism with a charge coupled device (CCD) camera (Kurg A, Tonisson N, Georgiou I, Shumaker J, Tollett J, Metspalu A: “Arrayed primer extension: solid-phase four-color DNA resequencing and mutation detection technology,” Genet Test 2000, 4:1-7). Sequence variants were individually identified using GENORAMA™ 4.2 genotyping software. This software allows automated base calls, which were subsequently verified through technical interpretation of each spot by review of an image of the four signals, a bargraph representing signal intensities, and review of the preliminary call at every mutation spot.

### II. Results

Fifty nine sequence variants, common to 15 genetic disorders that are most prevalent among Jewish populations, were selected for inclusion on the newly developed diagnostic APEX array. Mutations with a high allele frequency in the AJ population were especially selected, as they are very well characterized. Our aim was to develop a comprehensive diagnostic panel enabling carrier and disease detection among Jewish individuals and among individuals affected with disorders most prevalent in Jewish populations (Table 1). In other words, if a mutation was clearly associated with one of the conditions on the APEX array, but not specific to the AJ population, we aimed to include such a mutation in order to offer an optimally inclusive mutation panel. An example is the addition of the IVS7+1 G>A splice site mutation and the Δ7.6 kb deletion in the HEXA gene. Both of these mutations are relatively common in French Canadians. Additionally, the two well-characterized pseudodeficiency alleles for the HexA gene were included as well, to enable interpretation of apparent deficiencies found in the course of enzyme testing.

In order to evaluate all selected sequences present on the chip, sample DNA was amplified in 37 amplicons. All PCR mixes include a 20% substitution of dUTPs for dTTPs, which enables subsequent fragmentation with uracil N-glycosylase (UNG) as reported previously (Kurg et al., supra). Every sequence variant is identified by at least two unique 25 by oligonucleotides, typically one for the forward and one for the reverse strand. When mutations occur in neighboring nucleotides, however, the method permits a smaller number of identifying oligonucleotides. A total of 118 oligonucleotides were annealed to the APEX microarray slide in order to identify 59 sequence variants.

In 16 instances, the oligonucleotides originally designed for the microarray failed to perform the APEX reaction robustly. APEX primer failure is mainly due to self-annealing secondary structures that result in self-priming and extension or failure to hybridize altogether. On the assumption that these were the reasons for failure, we redesigned the initial 16 primers with either an incorporation of a single mismatch or the inclusion of a modified nucleotide at either the 5-prime end or internally. These changes can reduce primer self-complementarity without a negative effect on hybridization and extension. Our final set of APEX primers succeeded in eliminating secondary structure interference from all but six of the primers and detected 53 sequence variants (out of 59 variants at 58 amino acid locations) in both directions. Four were detected from only the sense strand (when the antisense direction does not work reliably: 1) mutation Δ7.6 kb in the HEXA gene, 2) mutation E167A in MEFV, 3) 167delT in GJB2, and 4) L444P in the GBA gene), and two from only the antisense strand (the sense direction does not work reliably: 1) mutation 1035insG in the GBA gene, and 2) ΔR608 in the SMPD gene). The reason for detecting variants on both DNA strands is primarily confirmatory, should there be a failure to obtain a good duplicate signal in one strand. While having this second internally confirming strategy in place is desirable, experience with the microarrays confers confidence that a clear duplicate signal from one strand provides specific, reproducible, and reliable results.

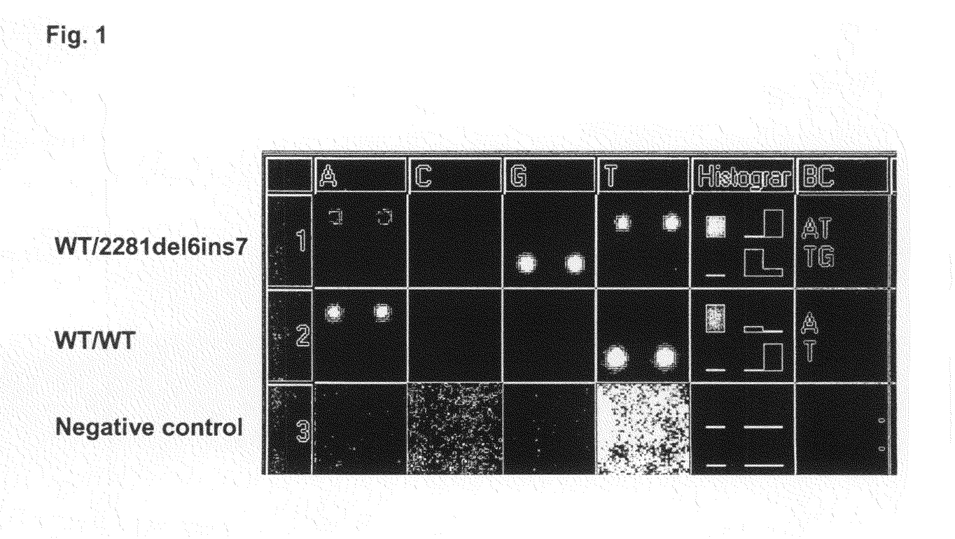

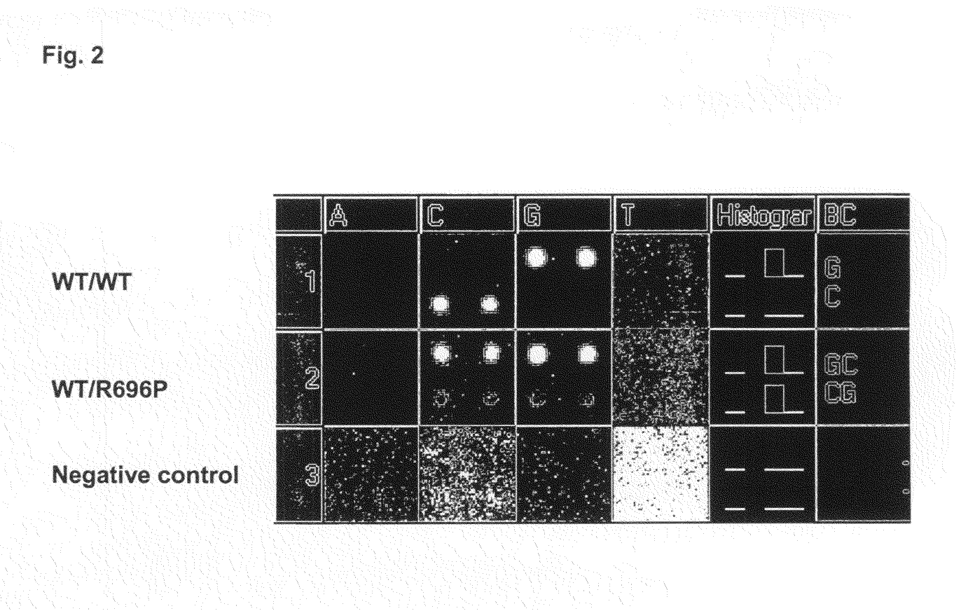

With the approach described above, sensitive and specific identification of the wild type (WT) and mutation alleles has been achieved for each variant interrogated by the APEX method on this microarray. In unaffected mutation carriers of autosomal recessive conditions, one or more heterozygous mutations are expected in the entire array, as long as the heterozygous mutations are not present in compound heterozygous form in the same gene. Strom et al. (“Molecular screening for diseases frequent in Ashkenazi Jews: lessons learned from more than 100,000 tests performed in a commercial laboratory,” Genet. Med. 2004, 6:145-152) reported that in a limited panel of eight AJ disorders, approximately one in seven individuals is a carrier of at least one heterozygous mutation. Affected patients are expected to carry two mutations, either two different mutations in the same gene or a homozygous mutation. FIGS. 1 and 2 illustrate representative results for a mutation in the BLM gene (Bloom syndrome; 2281del6ins7) and in the IKBMP gene (Familial dysautonomia; R696P).

The APEX microarray for Jewish disorders was validated with 23 patient samples, of which five were blind to the operator (Table 2), with 19 different mutations. Mutations for which genomic DNA from patients or carriers could not be obtained were tested with synthetic oligonucleotides (Table 3), the content of which was based on the wild type sequence but with incorporation of the mutation of interest.

TABLE 3
Synthetic oligonucleotides designed for
detection evaluation on the AJ APEX array.

| | Synthetic oligonucleotides (5′ > 3′) | |
|---|---|---|
| Disorder, gene | underlining indicates mutated/inserted | |
| mutation(s) | nucleotide(s)][indicates site of deletion | SEQ ID NO |
| Bloom Syndrome: BLM | | |
| 736delATCTGAinsTAGA | TTTTATACTTAGATTCCAGCTACAT][TAGATTCCA | 1 |
| TTC (2281del6/ins7) | GGTGATAAGACTGACTCAGAAGC | |
| Canavan: ASPA | | |
| Y231X (693C > A) | ATAAAATTATAGAGAAAGTTGATTAACCCCGGGA | 2 |
| | TGAAAATGGAGAAATTG | |
| E285A (854 A > C) | ACCGTGTACCCCGTGTTTGTGAATGCGGCCGCA | 3 |
| | TATTACGAAAAGAAAGAA | |
| A305E (914C > A) | AAGACAACTAAACTAACGCTCAATGAAAAAAGTA | 4 |
| | TTCGCTGCTGTTTACAT | |
| IVS2-2A > G | AAGAAAGACGTTTTTGATTTTTTTCGGACTTCTCT | 5 |
| | GGCTCCACTACCCTGC | |
| Factor XI Deficiency: | | |
| F11 | | |
| IVS14 + 1G > A | GGAAGGAGGGAAGGACGCTTGCAAGATAACAGA | 6 |
| | GTGTTCTTAGCCAATGGA | |
| E117X (576G > T) | CAGCTCAGTTGCCAAGAGTGCTCAATAATGCCA | 7 |
| | AGAAAGATGCACGGATGA | |
| F283L (1074T > C) | TTCTTCATTTTACCATGACACTGATCTCTTGGGA | 8 |
| | GAAGAACTGGATATTGT | |
| Familial Dysautonomia: | | |
| IKBPAP | | |
| IVS20 + 6T > C | ATTCGGAAGTGGTTGGACAAGTAAGCGCCATTG | 9 |
| | TACTGTTTGCGACTAGTT | |
| R696P (2397G > C) | CTGCGGAAAGTGGAGAGGGGTTCACCGATTGTC | 10 |
| | ACTGTTGTGCCCCAGGA | |
| Familial Mediterranean | | |
| Fever: MEFV | | |
| E148Q (442G > C) | TGCCAGCCTGCGGTGCAGCCAGCCCCAGGCCG | 11 |
| | GGAGGGGGCTGTCGAGGAA | |
| E167D (501G > C) | GCAAACGCAGAGAGAAGGCCTCGGACGGCCTG | 12 |
| | GACGCGCAGGGCAAGCCTC | |
| T267I (800C > T) | ATTCTCCTGACTCTAGAGGAAAAGATAGCTGCGA | 13 |
| | ATCTGGACTCGGCAACA | |
| P369S (1105C > T) | AAGGAAGAGCCCGGGAAGCCTAAGCTCCCAGC | 14 |
| | CCCTGCCACAGTGTAAGCG | |
| R408Q (1223G > A) | CTGAGTCAGGAGCACCAAGGCCACCAGGTGCG | 15 |
| | CCCCATTGAGGAGGTCGCC | |
| F479L (1437C > G) | ACTTCCTGGAGCAGCAAGAGCATTTGTTTGTGG | 16 |
| | CCTCACTGGAGGACGTGG | |
| R653H (1958G > A) | TCTCCGAGTTTCCTCTCTGGCCGCCATTACTGG | 17 |
| | GAGGTGGAGGTTGGAGAC | |
| M6801 (2040G > C) | CATCCATAAGCAGGAAAGGGAACATCACTCTGT | 18 |
| | CGCCAGAGAATGGCTACT | |
| ΔI 692 (de12076-2078) | CAGAGAATGGCTACTGGGTGGTGAT][GATGAAG | 19 |
| | GAAAATGAGTACCAGG | |
| M694V (2080A > G) | GAATGGCTACTGGGTGGTGATAATGGTGAAGGA | 20 |
| | AAATGAGTACCAGGCGTC | |
| M694I(2082G > A) | ATGGCTACTGGGTGGTGATAATGATAAAGGAAA | 21 |
| | ATGAGTACCAGGCGTCCA | |
| K695R (2084A > G) | GGCTACTGGGTGGTGATAATGATAGAGGGAAAA | 22 |
| | TGAGTACCAGGCGTCCAGC | |
| V726A (2177T > C) | GTGGGCATCTTCGTGGACTACAGAGCTGGAAGC | 23 |
| | ATCTCCTTTTACAATGTG | |
| A744S (2230G > T) | AGCCAGATCCCACATCTATACATTCTCCAGCTGC | 24 |
| | TCTTTCTCTGGGCCCCT | |
| R761H (2282G > A) | CAACCTATCTTCAGCCCTGGGACACATGATGGA | 25 |
| | GGGAAGAACACAGCTCCT | |
| Fanconi Anemia: | | |
| FANCC | | |
| IVS4 + 4A > T (711 + 4A > T) | AAAACTTAACTCCTGGATACAGGTATGAGAGTAA | 26 |
| | ATCTTGCTCTGCACTTC | |
| R548X (1642C > T) | AAGCCCTAGATCAGAAAAACTGGCCTGAGAGCT | 27 |
| | CCTTAAAGAGCTGCGAAC | |
| 322delG | TTTGGATGCAGAAGCTTTCTGTATG][GATCAGGC | 28 |
| | CTTCCACTTTGGAAACC | |
| Q13X (37C > T) | TTCAGTAGATCTTTCTTGTGATTATTAGTTTTGGA | 29 |
| | TGCAGAAGCTTTCTGT | |
| Gaucher Disease type | | |
| 1: GBA | | |
| N370G (1226A > G) | TCTTTGCCTTTGTCCTTACCCTAGAGCCTCCTGT | 30 |
| | ACCATGTGGTCGGCTGG | |
| L444P (1448T > C) | CTGGTTGCCAGTCAGAAGAACGACCCGGACGCA | 31 |
| | GTGGCACTGATGCATCCC | |
| 84insG | TCATGGCTGGCAGCCTCACAGGATTGGCTTCTA | 32 |
| | CTTCAGGCAGTGTCGTGG | |
| IVS2 + 1G > A | CTTCAGGCAGTGTCGTGGGCATCAGATGAGTGA | 33 |
| | GTCAAGGCAGTGGGGAGG | |
| R496H (1604G > A) | TCCATTCACACCTACCTGTGGCGTCACCAGTGAT | 34 |
| | GGAGCAGATACTCAAGG | |
| V394L (1307G > T) | GAACCCCGAAGGAGGACCCAATTGGTTGCGTAA | 35 |
| | CTTTGTCGACAGTCCCAT | |
| 1035insG | GCCTGGGCTTCACCCCTGAACATCAGGCGAGAC | 36 |
| | TTCATTGCCCGTGACCTA | |
| GLYCOGEN STORAGE | | |
| DISEASE TYPE 1A: G6PC | | |
| R82C (326C > T) | TTTCCATAGGATTCTCTTTGGACAGTGTCCATAC | 37 |
| | TGGTGGGTTTTGGATAC | |
| GLYCOGEN STORAGE | | |
| DISEASE TYPE III: AGL | | |
| (GDE) | | |
| 1484ΔT 4455DELT) | TATAGTTTTGGTTAAAAATGTTCT][TCCCGACATT | 38 |
| | ATGTTCATCTTGAGA | |
| MAPLE SYRUP URINE | | |
| DISEASE: BCKHDB | | |
| R183P (548 G > C) | TTTAACTGTGGAAGCCTCACTATCCCGRCCCCTT | 39 |
| | GGGGCTGTGTTGGTCAT | |
| G278S (832G > A) | GAGTGATGTTACTCTAGTTGCCTGGAGCACTCA | 40 |
| | GGTGAGAGCATTGATCC | |
| E372X (1114G > T) | TGACACACCATTTCCTCACATTTTTTAACCATTCT | 41 |
| | ACATCCCAGACAAATG | |
| Mucolipidosis IV: | | |
| MCOLN I | | |
| IVS-2A > G | ACAGGCCCTCCCCTTCTCTGCCCACGGTACCTG | 42 |
| | GCGTTGCCTGACGTGTCA | |
| ΔEx1 → Ex7 | CACTGCAGCCTCGACCTCCTGGGCTCAAGCGAT | 43 |
| | CCTCC][AGATCACGTTTGACAACAAAGCACACA | |
| | GTGGGCGGATCC | |
| NIEMANN-PICK TYPE A: | | |
| SMPD1 | | |
| L302P (905T > C) | CGGGCCCTGACCACCGTCACAGCACCTGTGAG | 44 |
| | GAAGTTCCTGGGGCCAGTG | |
| FsP330 | ACACCTGTCAATAGCTTCCCTCC][CCCTTCATTG | 45 |
| | AGGGCAACCACTC | |
| R496L (1487G > T) | CAGCCCCACATCCTTGCAGGTTACCTTGTGACC | 46 |
| | AAATAGATGGAAACTACTCC | |
| Δ 608 | TGCCCGTGCTGACAGCCCTGCTCTG][CGCCACC | 47 |
| | TGATGCCAGATGGGAGCC | |
| Non-syndromic | | |
| Sensorineural Hearing | | |
| Loss: GJB2 | | |
| 35DELG | GGCACGCTGCAGACGATCCT][GGGGGTGTGAA | 48 |
| | CAAACACTCCACCA | |
| 167 ΔT | TGCAACACCC][GCAGCCAGGCTGCAAGAACGTG | 49 |
| | TGC | |
| Tay-Sachs Disease: | | |
| Hex A | | |
| G296S (805G > A) | TGGCCACACTTTGTCCTGGGGACCAAGTAAGAT | 50 |
| | GATGTCTGGGACCAGAG | |
| 1278iNsTATC | CCCCCTGGTACCTG/AACCGTATATCTATCCTAT | 51 |
| | GGCCCTGACTGGAAGGAA | |
| IVS12 + 1G > C | ACACAAACCTGGTCCCCAGGCTCTGCTAAGGGT | 52 |
| | TTTCGGGGGGGAGGTGGA | |
| IVS9 + 1G > A | AGCTGGAGTCCTTCTACATCCAGACATGAGGAA | 53 |
| | GGAAGGAGGGTCGGGTGGG | |
| R249W (745C > T) | GGAGGTCATTGAATACAGCACGGCTCTGGGGTA | 54 |
| | TCCGTGTGCTTGCAGAGTT | |
| R247W (739C > T) | TGTGAAGGAGGTCATTGAATACGACATGGCTCC | 55 |
| | GGGGTATCCGTGTGCTTGC | |
| IVS7 + 1G > A | GGCCACACTTTGTCCTGGGGACCAGATAAGAAT | 56 |
| | GATGTCTGGGACCAGAGG | |
| Δ7.6kb | AATTATTATTGACTATAGTCACCCT][ATTGTGCTC | 57 |
| | TCGAATAGTATGTCTT | |
| Torsion Dystonia: DYT1 | | |
| ΔE302 | AGACATTGTAAGCAGAGTGGCT][GAGATGACAT | 58 |
| | TTTTCCCCAAAGAGG | |
| ΔF323-Y328 | TCTCAGATAAAGGCTGCAAAACGGT][TTACTACG | 59 |
| | ATGATTGACAGTCATGA | |

All sites for which genomic DNA was available were tested with synthetic oligonucleotides as well, and results were congruent. The specific sequences employed in the assay are provided in Table 4.

TABLE 4
AJ Mutation Oligos

| | | SEQ |
|---|---|---|
| Primer name | Primer Sequence 5′ -> 3′ | ID NO |
| HEXA_i1278V1se | CTGCCCCCTGGTACCTGAACCGTAT | 60 |
| | ATC | |
| HEXA_INSTATC1278as | TCCTTCCAGTCAGGGCCATAGGATA | 61 |
| HEXA_+ 1IVS12s | ACACAAACCTGGTCCCAAGGCTCTG | 62 |
| HEXA_+ 1IVS12as | CCACCTCCCCCCCGAAAACCCTTA | 63 |
| HEXA_G269Ss | TGGCCACACTTTGTCCTGGGGACCA | 64 |
| HEXA_G269Sas | TCCCTCTGGTCCCAGACATCATTCT | 65 |
| | TAC | |
| HEXA_+ 1IVS9s | AGCTGGAGTCCTTCTACATCCAGAC | 66 |
| HEXA_+ 1IVS9V1as | GACCCCACCCACCCTCCTTCCTTCC | 67 |
| | TCA | |
| HEXA_R249Wse | GGAGGTCATTGAATACGCACGGCTC | 68 |
| HEXA_R249Was | AACTCTGCAAGCACACGGATACCCC | 69 |
| HEXA_R247Wse | TGTGAAGGAGGTCATTGAATACGCA | 70 |
| HEXA_R247Was | GCAAGCACACGGATACCCCGGAGCC | 71 |
| HEXA_IVS7 + 1GAse | GGCCACACTTTGTCATGGGGACCAG | 72 |
| HEXA_IVS7 + 1GAas | CCTCTGGTCCCAGACATCATTCTTA | 73 |
| HEXA_DEL7.6KBse | TATACAATTATTATTGACTATAGTC | 74 |
| (norm) | ACCCT | |
| HEXA_DEL7.6KBas | CATGCGTCTGTAGTCCTAGCTACTC | 75 |
| | A | |
| BLM_2281del6ins7se | TACTTTTATACTTAGATTCCAGCTA | 76 |
| | CAT | |
| BLM_2281del6ins7as | GCTTCTGAGTCAGTCTTATCACCTG | 77 |
| ASPA_433-2AGse | CCTAAGAAAGACGTTTTTGATTTTT | 78 |
| | TTC | |
| ASPA_433-2AGas | GCAGGGTAGTGGAGCCAGAGAAGTC | 79 |
| ASPA_Y231Xse | GGTCTATAAAATTATAGAGAAAGTT | 80 |
| | GATTA | |
| ASPA_Y231Xas | CAATTTCTCCATTTTCATCCCGGGG | 81 |
| ASPA_E285Ase | ACCGTGTACCCCGTGTTTGTGAATG | 82 |
| ASPA_E285Aas | TTCTTTCTTTTCGTAATATGCGGCC | 83 |
| ASPA_A305Ese | AAGACAACTAAACTAACGCTCAATG | 84 |
| ASPA_A305Eas | ATGTAAACAGCAGCGAATAC | 85 |
| SMPD_L302Pse | GGCCCTGACCACCGTCACAGCAC | 86 |
| SMPD_L302Pas | CACTGGCCCCAGGAACTTCCTCACA | 87 |
| SMPD_330DELCse | ACCTGTCAATAGCTTCCCTCCCCC | 88 |
| SMPD_330DELCas | GAGTGGTTGCCCTCAATGAAGGGGG | 89 |
| SMPD_R496Lse | CAGCCCCACATCCTTGCAAGTTACC | 90 |
| SMPD_R496Las | GGAGTAGTTTCCATCTATTTGGTAC | 91 |
| | ACA | |
| SMPD_DELR608se | CCCGTGCTGACAGCCCTGCTCTG | 92 |
| SMPD_DELR608as | CTCCCATCTGGCATCAGGTGGCG | 93 |
| IKBKAP_R696Pse | CTGCGGAAAGTGGAGAGGGGTTCAC | 94 |
| IKBKAP_R696Pas | GTCCTGGGGCACAACAGTGACAATC | 95 |
| IKBKAP_IVS20 + 6s | ATTCGGAAGTGGTTGGACAAGTAAG | 96 |
| IKBKAP_IVS20 + 6as | AACTAGTCGCAAACAGTACAATGGC | 97 |
| DYT_DELE302/303se | AGACATTGTAAGCAGAGTGGCTGAG | 98 |
| DYT_DELE302/303as | CCTCTTTGGGGAAAAATGTCATCTC | 99 |
| DYT_DELF323-Y328se | TCTCAGATAAAGGCTGCAAAACGGT | 100 |
| DYT_DELF323-Y328as | TCATGACTGTCAATCATCGTAGTAA | 101 |
| MCOLN_IVS3-2se | ACAGGCCCTCCCCTTCTCTGCCCAC | 102 |
| MCOLN_IVS3-2as | TGACACGTCAGGCAACGCCAGGTAC | 103 |
| MCOLN_DELEX1-7se | CACTGCAGCCTCGACCTCCTGGGCT | 104 |
| MCOLN_DELEX1-7as | GGATCCGCCCACTGTGTGCTTTGTT | 105 |
| FANCC_Q13Xse | TTCAGTAGATCTTTCTTGTGATTAT | 106 |
| FANCC_Q13Xas | ACAGAAAGCTTCTGCATCCAAAACT | 107 |
| FANCC_322deIGse | TTGGATGCAGAAGCTTTCTGTATGG | 108 |
| FANCC_322deIGas | GGTTTCCAAAGTGGAAGCCTGATCC | 109 |
| FANCC-IVS4 + 4V1se | GATTACTATCCTGGTTTGCTTAAAA | 110 |
| | ATGTG | |
| FANCC-IVS4 + 4V1as | AACATTTCAAAAGTGATAAATTTTA | 111 |
| | AATAC | |
| FANCC_R548Xse | AAGCCCTAGATCAGAAAAACTGGCC | 112 |
| FANCC_R548Xas | GTTCGCAGCTCTTTAAGGAGCTCTC | 113 |
| GBA_84insGse | CATGGCTGGCAGCCTCACAGGATTG | 114 |
| GBA_84insGas | CCACGACACTGCCTGAAGTAGAAGC | 115 |
| GBA_IVS2 + 1se | CTTCAGGCAGTGTCGTGGGCATCAG | 116 |
| GBA_IVS2 + 1as | CCTCCCCACTGCCTTGACTCACTCA | 117 |
| GBA_1035insGse | CCTGGGCTTCACCCCTGAACATCAG | 118 |
| GBA_1035insGas | TAGGTCACGGGCAATGAAGTCTCGC | 119 |
| GBA_N370Sse | TCTTTGCCTTTGTCCTTACCCTAGA | 120 |
| GBA_N370Sas | CCAGCCGACCACATGGTACAGGAGG | 121 |
| GBA_V394Lse | GAACCCCGAAGGAGGACACAATTGG | 122 |
| GBA_V394Las | ATGGGACTGTCGACAAAGTTACGCA | 123 |
| GBA_L444Pse | CTGGTTGCCAGTCAGAAGAACGACC | 124 |
| GBA_L444Pas | GGGATGCATCAGTGCCACTGCGTCC | 125 |
| GBA_R496Hse | TCCATTCACACCTACCTGTGGCGTC | 126 |
| GBA_R496Has | CCTTGAGTATCTGCTCCATCACTGG | 127 |
| F11_E117Xse | CAGCTCAGTTGCCAAGAGTGCTCAA | 128 |
| F11_E117Xas | TCATCCGTGCATCTTTCTTGGCATT | 129 |
| F11_F283Lse | TTCTTCATTTTACCATGACACTGAT | 130 |
| F11_F283Las | ACAATATCCAGTTCTTCTCCCAAGA | 131 |
| F11_IVS14 + 1GAse | GGAAGGAGGGAAGGACGATTGCAAG | 132 |
| F11_IVS14 + 1GAas | TTCCATTGGCTAAGAACACTCTGTTA | 133 |
| ASG_6PCR_83CV1s | TGTTTTTCCATAGGATTCTCTTTGGA | 134 |
| | CAG | |
| G6PC_R83Cas | GTATCCAAAACCCACCAGTATGGAC | 135 |
| BCKAD_R183Pse | TTTAACTGTGGAAGCCTCACTATCC | 136 |
| BCKAD_R183Pas | ATGACCAACACAACCCCAAGGGGAC | 137 |
| BCKAD_G278Sse | GGAGTGATGTTACTCTAGTTGCCTGG | 138 |
| BCKAD_G278Sas | GGATCAATGCTACTCACCTGAGTGC | 139 |
| BCKAD_E372Xse | TGACACACCATTTCCTCACATTTTT | 140 |
| BCKAD_E372Xas | CCATTTGTCTGGGATGTAGAATGGTT | 141 |
| GJB2_30dGse | GGCACGCTGCAGACGATCCTGGGGG | 142 |
| GJB2_30dGas | TGGTGGAGTGTTTGTTCACACCCCC | 143 |
| GJB2_167dTse | CAGGCCGACTTTGTCTGCAACACCC | 144 |
| GJB2_167dTas | GCACACGTTCTTACAGCCTGGCTGC | 145 |
| MEFV_E148Qse | GCCAGCCTGCAGTGCAGCCAGCCC | 146 |
| MEFV_E148Qas | TCCTCGACAACCCCCTCCCGGCCT | 147 |
| MEFV_E167Ase | GCAAACGCAGAGAGAAGGCCTCGGA | 148 |
| MEFV_E167Aas | AGGCTTGCCCTGCGCGTCCAGGCC | 149 |
| MEFV_T267Ise | AAATTCTCCTGACTCTAGAGGAAAA | 150 |
| | GA | |
| MEFV_T267Ias | TGTTGCCGAGTCCAGATTCGCAGCT | 151 |
| MEFV_P369Sse | AAGGAAGAGCCCGGGAAGCCTAAGC | 152 |
| MEFV_P369Sas | GCTTACACTGTGGCAGGGGCTGGG | 153 |
| MEFV_R408Qse | CTGAGTCAGGAGCACCAAGGCCACC | 154 |
| MEFV_R408Qas | GCGACCTCCTCAATAGGGCGCACC | 155 |
| MEFV_F479Lse | ACTTCCTGGAGCAGCAAGAGCATTT | 156 |
| MEFV_F479Las | CCACGTCCTCCAGTGAGGCCACAAA | 157 |
| MEFV_R653Hse | TCTCCGAGTTTCCTCTCTAGCCGCC | 158 |
| MEFV_R653Has | GTCTCCAACCTCCACCTCCCAGTAA | 159 |
| MEFV_M6801se | CATCCATAAGCAGGAAAGGGAACAT | 160 |
| MEFV_M680Ias | AGTAGCCATTCTCTGACGACAGAGT | 161 |
| MEFV_692dIse | CAGAGAATGGCTACTGGGTGGTGAT | 162 |
| MEFV_692dlas | CCTGGTACTCATTTTCCTTCATCAT | 163 |
| MEFV_M694Vse | GAATGGCTACTGGGTGGTGATAATG | 164 |
| MEFV_M694Vas | GACGCCTGGTACTCATTTTCCTTCA | 165 |
| MEFV_M694Ise | ATGGCTACTGGGTGGTGATAATGAT | 166 |
| MEFV_M694Ias | TGGACGCCTGGTACTCA CCTT | 167 |
| MEFV_K695Rse | GGCTACTGGGTGGTGATAATGATGA | 168 |
| MEFV_K695Ras | GCTGGACGCCTGATACTCATTTTCC | 169 |
| MEFV_V726Ase | GTGGGCATCTTCGTGGACTACAGAG | 170 |
| MEFV_V726Aas | CACATTGTAAAAGGAGATGCTTCCA | 171 |
| MEFV_A744Sse | AGCCAGATCCCACATCTATACATTC | 172 |
| MEFV_A744Sas | AGGGGCACAGAGAAAGAGCAGCTGG | 173 |
| MEFV_R761Hse | CAACCTATCTTCAGCCCTGGGACAC | 174 |
| MEFV_R761Has | AGGAGCTGTGTTCTTCCCTCCATCA | 175 |
| GDE_1484dTse | AGACTATAGTTTTGGTTAAAAATGT | 176 |
| | TCTT | |
| GDE_1484dTas | TCTCAAGATGAACATAATGTCGGGAA | 177 |

With this initial validation series, no false negatives or false positives were observed. Thus, sensitivity (TP/TP+FN) and specificity (TN/TN+FP) were each 100%. The APEX reactions are entirely reproducible under standardized and requisite testing conditions. These conditions include: 1) the requirement of good quality of the DNA sample; 2) optimized PCR amplification; 3) successful fragmentation of the UNG-treated PCR product; 4) and 5) optimized and individually validated arrayed primers. For this APEX array, each individual sequence variant was tested 3-10 times using synthetic oligonucleotides and some patient samples. The results were highly reproducible from array to array. In addition, individual batches of arrays undergo quality control testing before they are put into use, in accordance with ISO 9001 quality standards by Bureau Veritas Quality International (BVQI).

A number of oligonucleotides that find use in detecting certain CFTR gene mutations as described herein have been designed and employed, some of which are listed below.

TABLE 5
CFTR Gene Mutation Oligonucleotides

| GENORAMATM | GENORAMATM | APEX oligo | | SEQ ID |
|---|---|---|---|---|
| Ref.S | Ref.AS | name | Sequence 5′->3′ | NO |
| G85E s a/G | G85E as t/C | cf-G85E s | TTTTTCTGGAGATTTATGT | 178 |
| | | | TCTATG | |
| | | cf-G85E as | CCTTACCCCTAAATATAA | 179 |
| | | | AAAGATT | |
| R117HPL s | R117HPL asV4 | cf-R117HPL s | ATGACCCGGATAACAAGG | 180 |
| act/G | tga/C | | AGGAAC | |
| | | cf-R117HPL | TATGCCTAGATAAATZGZ | 181 |
| | | asV4 | GATAGAG | |
| | | cf-R117HPL | GCCTATGCCTAGATAAAT | 182 |
| | | asV5 | ZGZGATAGAG | |
| 621 + 1G > T s t/G | 621 + 1G > T as | cf-621 + 1G > T s | TATGTTTAGTTTGATTTAT | 183 |
| | a/C | | AAGAAG | |
| | | cf-621 + 1G > T as | ATGGGGCCTGTGCAAGG | 184 |
| | | | AAGTATTA | |
| 711 + 1G > T s t/G | 711 + 1G > T as | cf-711 + 1G > T s | CAACAACCTGAACAAATT | 185 |
| | a/C | | TGATGAA | |
| | | cf-711 + 1G > T as | AAAAGATTAAATCAATAG | 186 |
| | | | GTACATA | |
| R334W s t/C | R334W as a/G | cf-R334W s | TGCACTAATCAAAGGAAT | 187 |
| | | | CATCCTC | |
| | | cf-R334W as | AATGAGATGGTGGTGAAT | 188 |
| | | | ATTTTCC | |
| R347HPL sV2 | R347HPL as | cf-R347HPL | CACCACCATCTCATTCTA | 189 |
| act/G | tga/C | sV2 | CATTGTTCTGC | |
| | | cf-R347HPL as | GGGAAATTGCCGAGTGA | 190 |
| | | | CCGCCATG | |
| A455E s a/C | A455E as t/G | cf-A455E s | AAGATAGAAAGAGGACAG | 191 |
| | | | TTGTTGG | |
| | | cf-A455E as | GCCTGCTCCAGTGGATC | 192 |
| | | | CAGCAACC | |
| Delta1507 s t/A | Delta1507 as | cf-Delta1507 s | GCCTGGCACCATTAAAGA | 193 |
| | a/G | | AAATATC | |
| | | cf-Delta1507 as | ATTCATCATAGGAAACAC | 194 |
| | | | CAAAGAT | |
| deltaF508 sV3 | deltaF508 as t/A | cf-delta F508 | GCCTGGCACCATTAAAGA | 195 |
| t/C | | sV3 | AAATATCAT | |
| | | cf-DeltaF508 as | CTATATTCATCATAGGAA | 196 |
| | | | ACACCAA | |
| 1717-1G > A s | 1717-1G > A as | cf-1717-1G > A s | CTCTAATTTTCTATTTTTG | 197 |
| a/G | t/C | | GTAATA | |
| | | cf-1717-1G > A | CTTTCTCTGCAAACTTGG | 198 |
| | | as | AGATGTC | |
| G542X s t/G | G542X as a/C | cf-G542X s | TGCAGAGAAAGACAATAT | 199 |
| | | | AGTTCTT | |
| | | cf-G542X as | CCACTCAGTGTGATTCCA | 200 |
| | | | CCTTCTC | |
| G551D s a/G | G551D as t/C | cf-G551D s | GAAGGTGGAATCACACTG | 201 |
| | | | AGTGGAG | |
| | | cf-G551D as | TGCTAAAGAAATTCTTGC | 202 |
| | | | TCGTTGA | |
| R553XG s tg/C | R553XG as | cf-R553XG s | TGGAATCACACTGAGTGG | 203 |
| | ac/G | | AGGTCAA | |
| | | cf-R553XG as | CACCTTGCTAAAGAAATT | 204 |
| | | | CTTGCTC | |
| R560TK s ca/G | R560TK as gt/C | cf-R560TK s | CAACGAGCAAGAATTTCT | 205 |
| | | | TTAGCAA | |
| | | cf-R560TK as | GCTAGACCAATAATTAGT | 206 |
| | | | TATTCAC | |
| 1898 + 1G > ATC | 1898 + 1G > ATC | cf-1898 + 1G > ATC | CCTAGATGTTTTAACAGA | 207 |
| sV2 atc/G | as tag/C | sV2 | AAAAGAAATATTTGAAAG | |
| | | cf-1898 + 1G > ATC | ATAAGTAAGGTATTCAAA | 208 |
| | | as | GAACATA | |
| 2184de1A (2183 | 2184delA(2183 | cf-2184de1A s | CTGTCTCCTGGACAGAAA | 209 |
| wt) s c/A | wt) asV1 g/T | | CAAAAAA | |
| | | cf-2184de1A | CCAGTCTGTTTAAAAGAT | 210 |
| | | asV1 | TGTTTTTT | |
| 2183AA > G | 2183AA > G as | cf-2183AA > G | GCTCCTGTCTCCTGGACA | 211 |
| sV3(2184 pos?) | (nt 2mutats.)c/T | sV3 | GAAACAAAAA | |
| g/A | | | | |
| | | cf-2183AA > G | CAAACTCTCCAGTCTGTT | 212 |
| | | as | TAAAAGATTG | |
| | 2183A > G as | cf-2183A > G as | CTCTCCAGTCTGTTTAAA | 213 |
| | (2184 wt) c/T | | AGATTGT | |
| 2789 + 5G > A s | 2789 + 5G > A as | cf-2789 + 5G > A s | TGTGCTGTGGCTCCTTGG | 214 |
| a/G | t/C | | AAAGTGA | |
| | | cf-2789 + 5G > A | AATCTACACAATAGGACA | 215 |
| | | as | TGGAATA | |
| 3120 + 1G > A s | 3120 + 1G > A as | cf-3120 + 1G > A s | TCTTACCATATTTGACTTC | 216 |
| a/G | t/C | | ATCCAG | |
| | | cf-3120 + 1G > A | ACTTAACGGTACTTATTTT | 217 |
| | | as | TACATA | |
| R1162X s t/C | R1162X as a/G | cf-R1162X s | TTTATTTCAGATGCGATCT | 218 |
| | | | GTGAGC | |
| | | cf-R1162X as | GGCATGTCAATGAACTTA | 219 |
| | | | AAGACTC | |
| 3659delC s a/C | 3659delC as t/G | cf-3659delC s | ACATGCCAACAGAAGGTA | 220 |
| | | | AACCTAC | |
| | | cf-3659delC as | ATTCTTGTATGGTTTGGTT | 221 |
| | | | GACTTG | |
| 3849+10kbC > T | 3849 + 10kbC > T | cf-3849 + 10kbC > T | TCCATCTGTTGCAGTATT | 222 |
| s t/C | as a/G | s | AAAATGG | |
| | | cf-3849 k bC > T | CATTTCCTTTCAGGGTGT | 223 |
| | | as | CTTACTC | |
| W1282XC s | W1282XC as | cf-W1282XC s | GGGATTCAATAACTTTGC | 224 |
| at/G | ta/C | | AACAGTG | |
| | | cf-W1282XC as | GTGGTATCACTCCAAAGG | 225 |
| | | | CTTTCCT | |
| N1303K sV3 | N1303K as c/G | cf-N1303K as | CACTCCACTGTTCATAGG | 226 |
| g/C | | | GATCCAA | |

### III. Discussion

We report the development of a population- and disease-specific arrayed primer extension (APEX) microarray that includes 59 sequence variants for cost-effective, rapid, and reliable detection of carrier or affected status in 15 different disorders that are prevalent in individuals of primarily AJ extraction. We have created a microarray that expands the current repertoire of testing, represents the majority of the conditions found primarily in the Ashkenazi Jewish population, and lays the groundwork for extending this panel to other diseases with mutations shared among various Jewish groups. Among the 15 conditions represented on this array:
Five result in mental retardation, neurologic deterioration, and childhood or pre-adult death (Tay-Sachs; Canavan; Maple Syrup Urine Disease; Niemann-Pick type A; Mucolipidosis type IV);
Three result in marked developmental delays and growth retardation (Familial dysautonomia; Fanconi anemia; Bloom syndrome);
Six have multiple system involvement, including skeletal, skin, bone marrow, and/or internal organs with variable severity and progressions (Familial dysautonomia; Glycogen storage disease type III; Gaucher disease; Glycogen storage disease type I; Fanconi anemia; Bloom syndrome), the last three of which also have marked predispositions to cancer;
One results in severe injury related bleeding (Factor XI deficiency); One in extreme fevers and synovitis (Familial Mediterranean Fever); One in later onset neurologic manifestations (Torsion dystonia) and one in childhood hearing loss (connexin-related sensorineural hearing loss).

Depending on the individual's geographic and ethnic history and the selection of the population carrier frequency on extracts from the literature, the likelihood of being a carrier for one of the autosomal recessive conditions on the microarray (i.e., excluding torsion dystonia) is approximately two in every five people. The diagnosis of any of these conditions is a foundation for appropriate medical care and interventions whereas the determination of heterozygosity (carrier status) is the basis for genetic counseling. The primary value and use of this microarray is in its capacity to provide diagnoses of the diseases associated with the selected mutations. Application of the technology to screening for conditions that are associated with mild to moderate morbidity or disability may not be high priorities and poses considerations and implications beyond the scope of this report, ranging from the appropriateness of inclusion on a panel to the role of genetic counseling as the capacity to generate data expands. In a related manner, inclusion of the pseudodeficiency alleles for Hex A (Tay-Sachs disease) may be better applied to an individual who has a positive enzyme-based screening than for a prenatal test. However, this technology may be readily modified for various applications, including screening, at low cost and may, for example, be the entrée to targeted newborn screening. Ideally, patients and their physicians would be able to choose the information they wish to receive from the array through a process of selective interpretation. Whereas the data as a whole cannot be blocked selectively, review and interpretation ultimately occurs spot-by-spot and could be guided by preselecting locations on the array, depending on whether the assay is performed for diagnostic, screening, or confirmatory purposes.

Tay-Sachs carrier screening is the prototype of successful population screening for inherited disease. It has been available in the U.S. since 1971 (by enzyme analysis). Carrier screening programs for this condition have enabled an international reduction of affected births by >90% (13). Carrier screening guidelines by the American College of Obstetricians and Gynecologists (AGOG) advise to screen all AJ couples for Cystic fibrosis, Canavan disease, Tay-Sachs disease, and Familial dysautonomia (3). Of these, only Cystic Fibrosis carrier screening is already offered routinely to anyone who considers having children. Because several other disorders have only slightly lower allele frequencies (Table 1) and are clinically similarly devastating, we developed a single APEX assay to encompass the most frequent conditions and mutations. Thus, potential carriers seeking genetic counseling and carrier screening can be tested with a single panel rather than sequentially or for a small subset of conditions. In addition, this assay is equally suitable for mutation detection in potentially affected patients. Finally, through inclusion of mutations that are specific to non-AJ groups and other select populations with a high carrier frequency for these disorders, the microarray is inclusive of mixed couples at risk, and potentially affected non-AJ patients.

In summary, the APEX array system presents a new diagnostic approach for comprehensive screening of Ashkenazi Jewish and other Jewish mutations, through an integrated system consisting of a single DNA microarrayed chip, multiplex primer extension on the array, and automated data analysis. The large number and selection of mutations on the AJ microarray results in a higher mutation detection capability than assays currently available in most diagnostic laboratories. This APEX assay is highly sensitive, specific, reproducible, and technically robust in our initial technical validation. Because the array is based on a platform technology, it is suitable for the detection of a variety of genetic disorders. In addition, it can easily be modified to accommodate additional mutations. The AJ APEX microarray is comprehensive and will allow a cost-effective approach for both carrier screening and disease detection in Ashkenazi and Sephardic Jewish populations.

To our knowledge, the APEX array reported here is the most comprehensive testing panel for the AJ population currently available. In addition, however, mutations common in other Jewish populations were included, as well as those few mutations specific for these conditions in other well-defined populations. Thus, diagnostic and risk evaluations are more optimally possible than without the inclusion of such mutations, especially in patients or couples of mixed ancestry.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A method of determining whether a subject carries a disease associated gene mutation common in Jewish populations, said method comprising:
(a) contacting an array comprising a plurality of distinct nucleic acid disease associated gene mutation probes immobilized on a surface of a solid support with a nucleic acid sample from said subject to produce a sample contacted array;
(b) contacting said sample contacted array with a polymerase and at least two different distinguishably labeled dideoxynucleotides under primer extension conditions; and
(c) detecting the presence of any resultant terminally labeled nucleic acids immobilized on said substrate surface to determine whether said subject carries a disease associated gene mutation common in Jewish populations.

2. The method according to claim 1, wherein said array comprises about 25 or more gene mutation probes for the mutations listed in Table 1.

3. The method according to claim 1, wherein said nucleic acid sample is an amplified genomic sample.

4. The method according to claim 3, wherein said amplified genomic sample is a fragmented amplified genomic sample.

5. The method according to claim 4, wherein said fragmented amplified genomic sample is an enzymatically fragmented sample.

6. The method according to claim 1, wherein said array comprises a plurality of pairs of disease associated gene mutation probes, wherein each pair comprises a sense strand probe and an antisense strand probe.

7. The method according to claim 1, wherein said sample contacted array is contacted with four different distinguishably labeled ddNTPs.

8. The method according to claim 7, wherein said four different distinguishably labeled ddNTPs are ddATP, ddTTP, ddGTP and ddCTP.

9. The method according to claim 1, wherein said at least two dideoxynucleotides are labeled with fluorescent labels.

10. The method according to claim 9, wherein said detecting step comprises scanning said surface for said at least two different fluorescent labels.

11. The method according to claim 10, wherein said surface is scanned for four different fluorescent labels.

12. The method according to claim 1, wherein said method is a method for determining whether said subject is heterozygous for a disease associated gene mutation.

13. The method according to claim 1, wherein said method is a method for determining whether said subject is homozygous for a disease associated gene mutation.

14. An array comprising a plurality of at about 25 or more distinct nucleic acid disease associated gene mutation probes immobilized on a surface of a solid support.

15. The array according to claim 14, wherein said about 25 or more distinct gene mutation probes are for the mutations listed in Table 1.

16. The array according to claim 14, wherein said array comprises a plurality of pairs of disease associated gene mutation probes, wherein each pair comprises a sense strand probe and an antisense strand probe.

17. The array according to claim 14, wherein said array comprises about 50 or more distinct nucleic acid disease associated gene mutation probes.

18. A method of determining whether a subject carries a disease associated gene mutation common in Jewish populations, said method comprising:
(a) contacting an array comprising a plurality of about 25 or more distinct nucleic acid disease associated gene mutation probes immobilized on a surface of a solid support with a nucleic acid sample of target nucleic acids from said subject to produce a sample contacted array;
(b) detecting the presence of any resultant target nucleic acids immobilized on said substrate surface to determine whether said subject carries a disease associated gene mutation common in Jewish populations.

19. A kit for use determining whether a subject carries a disease associated gene mutation common in Jewish populations, said kit comprising:
(a) an array comprising a plurality of about 25 distinct nucleic acid disease associated gene mutation probes immobilized on a surface of a solid support; and
(b) at least two different distinguishably labeled dideoxynucleotides (ddNTPs).

20. The kit according to claim 19, wherein said about 25 or more distinct disease associated gene mutation probes are for the mutations listed in Table 1.

21. The kit according to claim 19, wherein said array comprises a plurality of pairs of disease associated gene mutation probes, wherein each pair comprises a sense strand probe and an antisense strand probe.

22. The kit according to claim 19, wherein said array comprises at least about 50 distinct nucleic acid disease associated gene mutation probes.

23. The kit according to claim 19, wherein said kit comprises four different distinguishably labeled ddNTPs are ddATP, ddTTP, ddGTP and ddCTP.

24. The kit according to claim 19, wherein said at least two dideoxynucleotides are labeled with fluorescent labels.

25. A method of determining whether any of a plurality of subjects carry a disease associated gene mutation common in Jewish populations, said method comprising:
(a) producing a plurality of nucleic acid samples from said plurality of subjects, wherein each of said plurality of nucleic acid samples corresponds to one of said plurality of subjects;
(b) contacting each of said plurality of nucleic acid samples with an array comprising a plurality of distinct nucleic acid disease associated gene mutation probes immobilized on a surface of a solid support to produce a plurality of sample contacted arrays;
(c) contacting each of said plurality of sample contacted arrays with a polymerase and at least two different distinguishably labeled dideoxynucleotides under primer extension conditions; and
(d) detecting the presence of any resultant terminally labeled nucleic acids immobilized on said substrate surface to determine whether any of said plurality of subjects carry a disease associated gene mutation common in Jewish populations.

26. The method according to claim 25, wherein the accuracy of said method is about 90% or greater.

27. The method according to claim 26, wherein the accuracy of said method is about 97%.

28. The method according to claim 27, wherein the accuracy of said method is about 100%.


SEQUENCE LISTING (226 sequences)

SEQ ID NO: 1 - DNA, 57 bp, Artificial Sequence
  Synthetic oligonucleotide
ttttatacttagattccagctacattagattccaggtgataagactgactcagaagc

SEQ ID NO: 2 - DNA, 51 bp, Artificial Sequence
  Synthetic oligonucleotide
ataaaattatagagaaagttgattaaccccgggatgaaaatggagaaattg

SEQ ID NO: 3 - DNA, 51 bp, Artificial Sequence
  Synthetic oligonucleotide
accgtgtaccccgtgtttgtgaatgcggccgcatattacgaaaagaaagaa

SEQ ID NO: 4 - DNA, 51 bp, Artificial Sequence
  Synthetic oligonucleotide
aagacaactaaactaacgctcaatgaaaaaagtattcgctgctgtttacat

SEQ ID NO: 5 - DNA, 51 bp, Artificial Sequence
  Synthetic oligonucleotide
aagaaagacgtttttgatttttttcggacttctctggctccactaccctgc

SEQ ID NO: 6 - DNA, 51 bp, Artificial Sequence
  Synthetic oligonucleotide
ggaaggagggaaggacgcttgcaagataacagagtgttcttagccaatgga

SEQ ID NO: 7 - DNA, 51 bp, Artificial Sequence
  Synthetic oligonucleotide
cagctcagttgccaagagtgctcaataatgccaagaaagatgcacggatga

SEQ ID NO: 8 - DNA, 51 bp, Artificial Sequence
  Synthetic oligonucleotide
ttcttcattttaccatgacactgatctcttgggagaagaactggatattgt

SEQ ID NO: 9 - DNA, 51 bp, Artificial Sequence
  Synthetic oligonucleotide
attcggaagtggttggacaagtaagcgccattgtactgtttgcgactagtt

SEQ ID NO: 10 - DNA, 50 bp, Artificial Sequence
  Synthetic oligonucleotide
ctgcggaaagtggagaggggttcaccgattgtcactgttgtgccccagga

SEQ ID NO: 11 - DNA, 51 bp, Artificial Sequence
  Synthetic oligonucleotide
tgccagcctgcggtgcagccagccccaggccgggagggggctgtcgaggaa

SEQ ID NO: 12 - DNA, 51 bp, Artificial Sequence
  Synthetic oligonucleotide
gcaaacgcagagagaaggcctcggacggcctggacgcgcagggcaagcctc

SEQ ID NO: 13 - DNA, 51 bp, Artificial Sequence
  Synthetic oligonucleotide
attctcctgactctagaggaaaagatagctgcgaatctggactcggcaaca

SEQ ID NO: 14 - DNA, 51 bp, Artificial Sequence
  Synthetic oligonucleotide
aaggaagagcccgggaagcctaagctcccagcccctgccacagtgtaagcg

SEQ ID NO: 15 - DNA, 51 bp, Artificial Sequence
  Synthetic oligonucleotide
ctgagtcaggagcaccaaggccaccaggtgcgccccattgaggaggtcgcc

SEQ ID NO: 16 - DNA, 51 bp, Artificial Sequence
  Synthetic oligonucleotide
acttcctggagcagcaagagcatttgtttgtggcctcactggaggacgtgg

SEQ ID NO: 17 - DNA, 51 bp, Artificial Sequence
  Synthetic oligonucleotide
tctccgagtttcctctctggccgccattactgggaggtggaggttggagac

SEQ ID NO: 18 - DNA, 51 bp, Artificial Sequence
  Synthetic oligonucleotide
catccataagcaggaaagggaacatcactctgtcgccagagaatggctact

SEQ ID NO: 19 - DNA, 48 bp, Artificial Sequence
  Synthetic oligonucleotide
cagagaatggctactgggtggtgatgatgaaggaaaatgagtaccagg

SEQ ID NO: 20 - DNA, 51 bp, Artificial Sequence
  Synthetic oligonucleotide
gaatggctactgggtggtgataatggtgaaggaaaatgagtaccaggcgtc

SEQ ID NO: 21 - DNA, 51 bp, Artificial Sequence
  Synthetic oligonucleotide
atggctactgggtggtgataatgataaaggaaaatgagtaccaggcgtcca

SEQ ID NO: 22 - DNA, 52 bp, Artificial Sequence
  Synthetic oligonucleotide
ggctactgggtggtgataatgatagagggaaaatgagtaccaggcgtccagc

SEQ ID NO: 23 - DNA, 51 bp, Artificial Sequence
  Synthetic oligonucleotide
gtgggcatcttcgtggactacagagctggaagcatctccttttacaatgtg

SEQ ID NO: 24 - DNA, 51 bp, Artificial Sequence
  Synthetic oligonucleotide
agccagatcccacatctatacattctccagctgctctttctctgggcccct

SEQ ID NO: 25 - DNA, 51 bp, Artificial Sequence
  Synthetic oligonucleotide
caacctatcttcagccctgggacacatgatggagggaagaacacagctcct

SEQ ID NO: 26 - DNA, 51 bp, Artificial Sequence
  Synthetic oligonucleotide
aaaacttaactcctggatacaggtatgagagtaaatcttgctctgcacttc

SEQ ID NO: 27 - DNA, 51 bp, Artificial Sequence
  Synthetic oligonucleotide
aagccctagatcagaaaaactggcctgagagctccttaaagagctgcgaac

SEQ ID NO: 28 - DNA, 50 bp, Artificial Sequence
  Synthetic oligonucleotide
tttggatgcagaagctttctgtatggatcaggccttccactttggaaacc

SEQ ID NO: 29 - DNA, 51 bp, Artificial Sequence
  Synthetic oligonucleotide
ttcagtagatctttcttgtgattattagttttggatgcagaagctttctgt

SEQ ID NO: 30 - DNA, 51 bp, Artificial Sequence
  Synthetic oligonucleotide
tctttgcctttgtccttaccctagagcctcctgtaccatgtggtcggctgg

SEQ ID NO: 31 - DNA, 51 bp, Artificial Sequence
  Synthetic oligonucleotide
ctggttgccagtcagaagaacgacccggacgcagtggcactgatgcatccc

SEQ ID NO: 32 - DNA, 51 bp, Artificial Sequence
  Synthetic oligonucleotide
tcatggctggcagcctcacaggattggcttctacttcaggcagtgtcgtgg

SEQ ID NO: 33 - DNA, 51 bp, Artificial Sequence
  Synthetic oligonucleotide
cttcaggcagtgtcgtgggcatcagatgagtgagtcaaggcagtggggagg

SEQ ID NO: 34 - DNA, 51 bp, Artificial Sequence
  Synthetic oligonucleotide
tccattcacacctacctgtggcgtcaccagtgatggagcagatactcaagg

SEQ ID NO: 35 - DNA, 51 bp, Artificial Sequence
  Synthetic oligonucleotide
gaaccccgaaggaggacccaattggttgcgtaactttgtcgacagtcccat

SEQ ID NO: 36 - DNA, 51 bp, Artificial Sequence
  Synthetic oligonucleotide
gcctgggcttcacccctgaacatcaggcgagacttcattgcccgtgaccta

SEQ ID NO: 37 - DNA, 51 bp, Artificial Sequence
  Synthetic oligonucleotide
tttccataggattctctttggacagtgtccatactggtgggttttggatac

SEQ ID NO: 38 - DNA, 49 bp, Artificial Sequence
  Synthetic oligonucleotide
tatagttttggttaaaaatgttcttcccgacattatgttcatcttgaga

SEQ ID NO: 39 - DNA, 51 bp, Artificial Sequence
  Synthetic oligonucleotide
tttaactgtggaagcctcactatcccgrccccttggggctgtgttggtcat

SEQ ID NO: 40 - DNA, 50 bp, Artificial Sequence
  Synthetic oligonucleotide
gagtgatgttactctagttgcctggagcactcaggtgagagcattgatcc

SEQ ID NO: 41 - DNA, 51 bp, Artificial Sequence
  Synthetic oligonucleotide
tgacacaccatttcctcacattttttaaccattctacatcccagacaaatg

SEQ ID NO: 42 - DNA, 51 bp, Artificial Sequence
  Synthetic oligonucleotide
acaggccctccccttctctgcccacggtacctggcgttgcctgacgtgtca

SEQ ID NO: 43 - DNA, 77 bp, Artificial Sequence
  Synthetic oligonucleotide
cactgcagcctcgacctcctgggctcaagcgatcctccagatcacgtttgacaacaaagcacacagtgggcggatcc

SEQ ID NO: 44 - DNA, 51 bp, Artificial Sequence
  Synthetic oligonucleotide
cgggccctgaccaccgtcacagcacctgtgaggaagttcctggggccagtg

SEQ ID NO: 45 - DNA, 46 bp, Artificial Sequence
  Synthetic oligonucleotide
acacctgtcaatagcttccctcccccttcattgagggcaaccactc

SEQ ID NO: 46 - DNA, 53 bp, Artificial Sequence
  Synthetic oligonucleotide
cagccccacatccttgcaggttaccttgtgaccaaatagatggaaactactcc

SEQ ID NO: 47 - DNA, 50 bp, Artificial Sequence
  Synthetic oligonucleotide
tgcccgtgctgacagccctgctctgcgccacctgatgccagatgggagcc

SEQ ID NO: 48 - DNA, 45 bp, Artificial Sequence
  Synthetic oligonucleotide
ggcacgctgcagacgatcctgggggtgtgaacaaacactccacca

SEQ ID NO: 49 - DNA, 35 bp, Artificial Sequence
  Synthetic oligonucleotide
tgcaacacccgcagccaggctgcaagaacgtgtgc

SEQ ID NO: 50 - DNA, 50 bp, Artificial Sequence
  Synthetic oligonucleotide
tggccacactttgtcctggggaccaagtaagatgatgtctgggaccagag

SEQ ID NO: 51 - DNA, 51 bp, Artificial Sequence
  Synthetic oligonucleotide
ccccctggtacctgaaccgtatatctatcctatggccctgactggaaggaa

SEQ ID NO: 52 - DNA, 51 bp, Artificial Sequence
  Synthetic oligonucleotide
acacaaacctggtccccaggctctgctaagggttttcgggggggaggtgga

SEQ ID NO: 53 - DNA, 52 bp, Artificial Sequence
  Synthetic oligonucleotide
agctggagtccttctacatccagacatgaggaaggaaggagggtcgggtggg

SEQ ID NO: 54 - DNA, 52 bp, Artificial Sequence
  Synthetic oligonucleotide
ggaggtcattgaatacagcacggctctggggtatccgtgtgcttgcagagtt

SEQ ID NO: 55 - DNA, 52 bp, Artificial Sequence
  Synthetic oligonucleotide
tgtgaaggaggtcattgaatacgacatggctccggggtatccgtgtgcttgc

SEQ ID NO: 56 - DNA, 51 bp, Artificial Sequence
  Synthetic oligonucleotide
ggccacactttgtcctggggaccagataagaatgatgtctgggaccagagg

SEQ ID NO: 57 - DNA, 50 bp, Artificial Sequence
  Synthetic oligonucleotide
aattattattgactatagtcaccctattgtgctctcgaatagtatgtctt

SEQ ID NO: 58 - DNA, 47 bp, Artificial Sequence
  Synthetic oligonucleotide
agacattgtaagcagagtggctgagatgacatttttccccaaagagg

SEQ ID NO: 59 - DNA, 50 bp, Artificial Sequence
  Synthetic oligonucleotide
tctcagataaaggctgcaaaacggtttactacgatgattgacagtcatga

SEQ ID NO: 60 - DNA, 28 bp, Artificial Sequence
  Synthetic oligonucleotide
ctgccccctggtacctgaaccgtatatc

SEQ ID NO: 61 - DNA, 25 bp, Artificial Sequence
  Synthetic oligonucleotide
tccttccagtcagggccataggata

SEQ ID NO: 62 - DNA, 25 bp, Artificial Sequence
  Synthetic oligonucleotide
acacaaacctggtcccaaggctctg

SEQ ID NO: 63 - DNA, 24 bp, Artificial Sequence
  Synthetic oligonucleotide
ccacctcccccccgaaaaccctta

SEQ ID NO: 64 - DNA, 25 bp, Artificial Sequence
  Synthetic oligonucleotide
tggccacactttgtcctggggacca

SEQ ID NO: 65 - DNA, 28 bp, Artificial Sequence
  Synthetic oligonucleotide
tccctctggtcccagacatcattcttac

SEQ ID NO: 66 - DNA, 25 bp, Artificial Sequence
  Synthetic oligonucleotide
agctggagtccttctacatccagac

SEQ ID NO: 67 - DNA, 28 bp, Artificial Sequence
  Synthetic oligonucleotide
gaccccacccaccctccttccttcctca

SEQ ID NO: 68 - DNA, 25 bp, Artificial Sequence
  Synthetic oligonucleotide
ggaggtcattgaatacgcacggctc

SEQ ID NO: 69 - DNA, 25 bp, Artificial Sequence
  Synthetic oligonucleotide
aactctgcaagcacacggatacccc

SEQ ID NO: 70 - DNA, 25 bp, Artificial Sequence
  Synthetic oligonucleotide
tgtgaaggaggtcattgaatacgca

SEQ ID NO: 71 - DNA, 25 bp, Artificial Sequence
  Synthetic oligonucleotide
gcaagcacacggataccccggagcc

SEQ ID NO: 72 - DNA, 25 bp, Artificial Sequence
  Synthetic oligonucleotide
ggccacactttgtcatggggaccag

SEQ ID NO: 73 - DNA, 25 bp, Artificial Sequence
  Synthetic oligonucleotide
cctctggtcccagacatcattctta

SEQ ID NO: 74 - DNA, 30 bp, Artificial Sequence
  Synthetic oligonucleotide
tatacaattattattgactatagtcaccct

SEQ ID NO: 75 - DNA, 26 bp, Artificial Sequence
  Synthetic oligonucleotide
catgcgtctgtagtcctagctactca

SEQ ID NO: 76 - DNA, 28 bp, Artificial Sequence
  Synthetic oligonucleotide
tacttttatacttagattccagctacat

SEQ ID NO: 77 - DNA, 25 bp, Artificial Sequence
  Synthetic oligonucleotide
gcttctgagtcagtcttatcacctg

SEQ ID NO: 78 - DNA, 28 bp, Artificial Sequence
  Synthetic oligonucleotide
cctaagaaagacgtttttgatttttttc

SEQ ID NO: 79 - DNA, 25 bp, Artificial Sequence
  Synthetic oligonucleotide
gcagggtagtggagccagagaagtc

SEQ ID NO: 80 - DNA, 30 bp, Artificial Sequence
  Synthetic oligonucleotide
ggtctataaaattatagagaaagttgatta

SEQ ID NO: 81 - DNA, 25 bp, Artificial Sequence
  Synthetic oligonucleotide
caatttctccattttcatcccgggg

SEQ ID NO: 82 - DNA, 25 bp, Artificial Sequence
  Synthetic oligonucleotide
accgtgtaccccgtgtttgtgaatg

SEQ ID NO: 83 - DNA, 25 bp, Artificial Sequence
  Synthetic oligonucleotide
ttctttcttttcgtaatatgcggcc

SEQ ID NO: 84 - DNA, 25 bp, Artificial Sequence
  Synthetic oligonucleotide
aagacaactaaactaacgctcaatg

SEQ ID NO: 85 - DNA, 25 bp, Artificial Sequence
  Synthetic oligonucleotide
atgtaaacagcagcgaatacttttt

SEQ ID NO: 86 - DNA, 23 bp, Artificial Sequence
  Synthetic oligonucleotide
ggccctgaccaccgtcacagcac

SEQ ID NO: 87 - DNA, 25 bp, Artificial Sequence
  Synthetic oligonucleotide
cactggccccaggaacttcctcaca

SEQ ID NO: 88 - DNA, 24 bp, Artificial Sequence
  Synthetic oligonucleotide
acctgtcaatagcttccctccccc

SEQ ID NO: 89 - DNA, 25 bp, Artificial Sequence
  Synthetic oligonucleotide
gagtggttgccctcaatgaaggggg

SEQ ID NO: 90 - DNA, 25 bp, Artificial Sequence
  Synthetic oligonucleotide
cagccccacatccttgcaagttacc

SEQ ID NO: 91 - DNA, 28 bp, Artificial Sequence
  Synthetic oligonucleotide
ggagtagtttccatctatttggtacaca

SEQ ID NO: 92 - DNA, 23 bp, Artificial Sequence
  Synthetic oligonucleotide
cccgtgctgacagccctgctctg

SEQ ID NO: 93 - DNA, 23 bp, Artificial Sequence
  Synthetic oligonucleotide
ctcccatctggcatcaggtggcg

SEQ ID NO: 94 - DNA, 25 bp, Artificial Sequence
  Synthetic oligonucleotide
ctgcggaaagtggagaggggttcac

SEQ ID NO: 95 - DNA, 25 bp, Artificial Sequence
  Synthetic oligonucleotide
gtcctggggcacaacagtgacaatc

SEQ ID NO: 96 - DNA, 25 bp, Artificial Sequence
  Synthetic oligonucleotide
attcggaagtggttggacaagtaag

SEQ ID NO: 97 - DNA, 25 bp, Artificial Sequence
  Synthetic oligonucleotide
aactagtcgcaaacagtacaatggc

SEQ ID NO: 98 - DNA, 25 bp, Artificial Sequence
  Synthetic oligonucleotide
agacattgtaagcagagtggctgag

SEQ ID NO: 99 - DNA, 25 bp, Artificial Sequence
  Synthetic oligonucleotide
cctctttggggaaaaatgtcatctc

SEQ ID NO: 100 - DNA, 25 bp, Artificial Sequence
  Synthetic oligonucleotide
tctcagataaaggctgcaaaacggt

SEQ ID NO: 101 - DNA, 25 bp, Artificial Sequence
  Synthetic oligonucleotide
tcatgactgtcaatcatcgtagtaa

SEQ ID NO: 102 - DNA, 25 bp, Artificial Sequence
  Synthetic oligonucleotide
acaggccctccccttctctgcccac

SEQ ID NO: 103 - DNA, 25 bp, Artificial Sequence
  Synthetic oligonucleotide
tgacacgtcaggcaacgccaggtac

SEQ ID NO: 104 - DNA, 25 bp, Artificial Sequence
  Synthetic oligonucleotide
cactgcagcctcgacctcctgggct

SEQ ID NO: 105 - DNA, 25 bp, Artificial Sequence
  Synthetic oligonucleotide
ggatccgcccactgtgtgctttgtt

SEQ ID NO: 106 - DNA, 25 bp, Artificial Sequence
  Synthetic oligonucleotide
ttcagtagatctttcttgtgattat

SEQ ID NO: 107 - DNA, 25 bp, Artificial Sequence
  Synthetic oligonucleotide
acagaaagcttctgcatccaaaact

SEQ ID NO: 108 - DNA, 25 bp, Artificial Sequence
  Synthetic oligonucleotide
ttggatgcagaagctttctgtatgg

SEQ ID NO: 109 - DNA, 25 bp, Artificial Sequence
  Synthetic oligonucleotide
ggtttccaaagtggaagcctgatcc

SEQ ID NO: 110 - DNA, 30 bp, Artificial Sequence
  Synthetic oligonucleotide
gattactatcctggtttgcttaaaaatgtg

SEQ ID NO: 111 - DNA, 30 bp, Artificial Sequence
  Synthetic oligonucleotide
aacatttcaaaagtgataaattttaaatac

SEQ ID NO: 112 - DNA, 25 bp, Artificial Sequence
  Synthetic oligonucleotide
aagccctagatcagaaaaactggcc

SEQ ID NO: 113 - DNA, 25 bp, Artificial Sequence
  Synthetic oligonucleotide
gttcgcagctctttaaggagctctc

SEQ ID NO: 114 - DNA, 25 bp, Artificial Sequence
  Synthetic oligonucleotide
catggctggcagcctcacaggattg

SEQ ID NO: 115 - DNA, 25 bp, Artificial Sequence
  Synthetic oligonucleotide
ccacgacactgcctgaagtagaagc

SEQ ID NO: 116 - DNA, 25 bp, Artificial Sequence
  Synthetic oligonucleotide
cttcaggcagtgtcgtgggcatcag

SEQ ID NO: 117 - DNA, 25 bp, Artificial Sequence
  Synthetic oligonucleotide
cctccccactgccttgactcactca

SEQ ID NO: 118 - DNA, 25 bp, Artificial Sequence
  Synthetic oligonucleotide
cctgggcttcacccctgaacatcag

SEQ ID NO: 119 - DNA, 25 bp, Artificial Sequence
  Synthetic oligonucleotide
taggtcacgggcaatgaagtctcgc

SEQ ID NO: 120 - DNA, 25 bp, Artificial Sequence
  Synthetic oligonucleotide
tctttgcctttgtccttaccctaga

SEQ ID NO: 121 - DNA, 25 bp, Artificial Sequence
  Synthetic oligonucleotide
ccagccgaccacatggtacaggagg

SEQ ID NO: 122 - DNA, 25 bp, Artificial Sequence
  Synthetic oligonucleotide
gaaccccgaaggaggacacaattgg

SEQ ID NO: 123 - DNA, 25 bp, Artificial Sequence
  Synthetic oligonucleotide
atgggactgtcgacaaagttacgca

SEQ ID NO: 124 - DNA, 25 bp, Artificial Sequence
  Synthetic oligonucleotide
ctggttgccagtcagaagaacgacc

SEQ ID NO: 125 - DNA, 25 bp, Artificial Sequence
  Synthetic oligonucleotide
gggatgcatcagtgccactgcgtcc

SEQ ID NO: 126 - DNA, 25 bp, Artificial Sequence
  Synthetic oligonucleotide
tccattcacacctacctgtggcgtc

SEQ ID NO: 127 - DNA, 25 bp, Artificial Sequence
  Synthetic oligonucleotide
ccttgagtatctgctccatcactgg

SEQ ID NO: 128 - DNA, 25 bp, Artificial Sequence
  Synthetic oligonucleotide
cagctcagttgccaagagtgctcaa

SEQ ID NO: 129 - DNA, 25 bp, Artificial Sequence
  Synthetic oligonucleotide
tcatccgtgcatctttcttggcatt

SEQ ID NO: 130 - DNA, 25 bp, Artificial Sequence
  Synthetic oligonucleotide
ttcttcattttaccatgacactgat

SEQ ID NO: 131 - DNA, 25 bp, Artificial Sequence
  Synthetic oligonucleotide
acaatatccagttcttctcccaaga

SEQ ID NO: 132 - DNA, 25 bp, Artificial Sequence
  Synthetic oligonucleotide
ggaaggagggaaggacgattgcaag

SEQ ID NO: 133 - DNA, 26 bp, Artificial Sequence
  Synthetic oligonucleotide
ttccattggctaagaacactctgtta

SEQ ID NO: 134 - DNA, 29 bp, Artificial Sequence
  Synthetic oligonucleotide
tgtttttccataggattctctttggacag

SEQ ID NO: 135 - DNA, 25 bp, Artificial Sequence
  Synthetic oligonucleotide
gtatccaaaacccaccagtatggac

SEQ ID NO: 136 - DNA, 25 bp, Artificial Sequence
  Synthetic oligonucleotide
tttaactgtggaagcctcactatcc

SEQ ID NO: 137 - DNA, 25 bp, Artificial Sequence
  Synthetic oligonucleotide
atgaccaacacaaccccaaggggac

SEQ ID NO: 138 - DNA, 26 bp, Artificial Sequence
  Synthetic oligonucleotide
ggagtgatgttactctagttgcctgg

SEQ ID NO: 139 - DNA, 25 bp, Artificial Sequence
  Synthetic oligonucleotide
ggatcaatgctactcacctgagtgc

SEQ ID NO: 140 - DNA, 25 bp, Artificial Sequence
  Synthetic oligonucleotide
tgacacaccatttcctcacattttt

SEQ ID NO: 141 - DNA, 26 bp, Artificial Sequence
  Synthetic oligonucleotide
ccatttgtctgggatgtagaatggtt

SEQ ID NO: 142 - DNA, 25 bp, Artificial Sequence
  Synthetic oligonucleotide
ggcacgctgcagacgatcctggggg

SEQ ID NO: 143 - DNA, 25 bp, Artificial Sequence
  Synthetic oligonucleotide
tggtggagtgtttgttcacaccccc

SEQ ID NO: 144 - DNA, 25 bp, Artificial Sequence
  Synthetic oligonucleotide
caggccgactttgtctgcaacaccc

SEQ ID NO: 145 - DNA, 25 bp, Artificial Sequence
  Synthetic oligonucleotide
gcacacgttcttacagcctggctgc

SEQ ID NO: 146 - DNA, 24 bp, Artificial Sequence
  Synthetic oligonucleotide
gccagcctgcagtgcagccagccc

SEQ ID NO: 147 - DNA, 24 bp, Artificial Sequence
  Synthetic oligonucleotide
tcctcgacaaccccctcccggcct

SEQ ID NO: 148 - DNA, 25 bp, Artificial Sequence
  Synthetic oligonucleotide
gcaaacgcagagagaaggcctcgga

SEQ ID NO: 149 - DNA, 24 bp, Artificial Sequence
  Synthetic oligonucleotide
aggcttgccctgcgcgtccaggcc

SEQ ID NO: 150 - DNA, 27 bp, Artificial Sequence
  Synthetic oligonucleotide
aaattctcctgactctagaggaaaaga

SEQ ID NO: 151 - DNA, 25 bp, Artificial Sequence
  Synthetic oligonucleotide
tgttgccgagtccagattcgcagct

SEQ ID NO: 152 - DNA, 25 bp, Artificial Sequence
  Synthetic oligonucleotide
aaggaagagcccgggaagcctaagc

SEQ ID NO: 153 - DNA, 24 bp, Artificial Sequence
  Synthetic oligonucleotide
gcttacactgtggcaggggctggg

SEQ ID NO: 154 - DNA, 25 bp, Artificial Sequence
  Synthetic oligonucleotide
ctgagtcaggagcaccaaggccacc

SEQ ID NO: 155 - DNA, 24 bp, Artificial Sequence
  Synthetic oligonucleotide
gcgacctcctcaatagggcgcacc

SEQ ID NO: 156 - DNA, 25 bp, Artificial Sequence
  Synthetic oligonucleotide
acttcctggagcagcaagagcattt

SEQ ID NO: 157 - DNA, 25 bp, Artificial Sequence
  Synthetic oligonucleotide
ccacgtcctccagtgaggccacaaa

SEQ ID NO: 158 - DNA, 25 bp, Artificial Sequence
  Synthetic oligonucleotide
tctccgagtttcctctctagccgcc

SEQ ID NO: 159 - DNA, 25 bp, Artificial Sequence
  Synthetic oligonucleotide
gtctccaacctccacctcccagtaa

SEQ ID NO: 160 - DNA, 25 bp, Artificial Sequence
  Synthetic oligonucleotide
catccataagcaggaaagggaacat

SEQ ID NO: 161 - DNA, 25 bp, Artificial Sequence
  Synthetic oligonucleotide
agtagccattctctgacgacagagt

SEQ ID NO: 162 - DNA, 25 bp, Artificial Sequence
  Synthetic oligonucleotide
cagagaatggctactgggtggtgat

SEQ ID NO: 163 - DNA, 25 bp, Artificial Sequence
  Synthetic oligonucleotide
cctggtactcattttccttcatcat

SEQ ID NO: 164 - DNA, 25 bp, Artificial Sequence
  Synthetic oligonucleotide
gaatggctactgggtggtgataatg

SEQ ID NO: 165 - DNA, 25 bp, Artificial Sequence
  Synthetic oligonucleotide
gacgcctggtactcattttccttca

SEQ ID NO: 166 - DNA, 25 bp, Artificial Sequence
  Synthetic oligonucleotide
atggctactgggtggtgataatgat

SEQ ID NO: 167 - DNA, 25 bp, Artificial Sequence
  Synthetic oligonucleotide
tggacgcctggtactcattttcctt

SEQ ID NO: 168 - DNA, 25 bp, Artificial Sequence
  Synthetic oligonucleotide
ggctactgggtggtgataatgatga

SEQ ID NO: 169 - DNA, 25 bp, Artificial Sequence
  Synthetic oligonucleotide
gctggacgcctgatactcattttcc

SEQ ID NO: 170 - DNA, 25 bp, Artificial Sequence
  Synthetic oligonucleotide
gtgggcatcttcgtggactacagag

SEQ ID NO: 171 - DNA, 25 bp, Artificial Sequence
  Synthetic oligonucleotide
cacattgtaaaaggagatgcttcca

SEQ ID NO: 172 - DNA, 25 bp, Artificial Sequence
  Synthetic oligonucleotide
agccagatcccacatctatacattc

SEQ ID NO: 173 - DNA, 25 bp, Artificial Sequence
  Synthetic oligonucleotide
aggggcacagagaaagagcagctgg

SEQ ID NO: 174 - DNA, 25 bp, Artificial Sequence
  Synthetic oligonucleotide
caacctatcttcagccctgggacac

SEQ ID NO: 175 - DNA, 25 bp, Artificial Sequence
  Synthetic oligonucleotide
aggagctgtgttcttccctccatca

SEQ ID NO: 176 - DNA, 29 bp, Artificial Sequence
  Synthetic oligonucleotide
agactatagttttggttaaaaatgttctt

SEQ ID NO: 177 - DNA, 26 bp, Artificial Sequence
  Synthetic oligonucleotide
tctcaagatgaacataatgtcgggaa

SEQ ID NO: 178 - DNA, 25 bp, Artificial Sequence
  Synthetic oligonucleotide
tttttctggagatttatgttctatg

SEQ ID NO: 179 - DNA, 25 bp, Artificial Sequence
  Synthetic oligonucleotide
ccttacccctaaatataaaaagatt

SEQ ID NO: 180 - DNA, 24 bp, Artificial Sequence
  Synthetic oligonucleotide
atgacccggataacaaggaggaac

SEQ ID NO: 181 - DNA, 25 bp, Artificial Sequence
  Synthetic oligonucleotide
tatgcctagataaatcgcgatagag

SEQ ID NO: 182 - DNA, 28 bp, Artificial Sequence
  Synthetic oligonucleotide
gcctatgcctagataaatcgcgatagag

SEQ ID NO: 183 - DNA, 25 bp, Artificial Sequence
  Synthetic oligonucleotide
tatgtttagtttgatttataagaag

SEQ ID NO: 184 - DNA, 25 bp, Artificial Sequence
  Synthetic oligonucleotide
atggggcctgtgcaaggaagtatta

SEQ ID NO: 185 - DNA, 25 bp, Artificial Sequence
  Synthetic oligonucleotide
caacaacctgaacaaatttgatgaa

SEQ ID NO: 186 - DNA, 25 bp, Artificial Sequence
  Synthetic oligonucleotide
aaaagattaaatcaataggtacata

SEQ ID NO: 187 - DNA, 25 bp, Artificial Sequence
  Synthetic oligonucleotide
tgcactaatcaaaggaatcatcctc

SEQ ID NO: 188 - DNA, 25 bp, Artificial Sequence
  Synthetic oligonucleotide
aatgagatggtggtgaatattttcc

SEQ ID NO: 189 - DNA, 29 bp, Artificial Sequence
  Synthetic oligonucleotide
caccaccatctcattctacattgttctgc

SEQ ID NO: 190 - DNA, 25 bp, Artificial Sequence
  Synthetic oligonucleotide
gggaaattgccgagtgaccgccatg

SEQ ID NO: 191 - DNA, 25 bp, Artificial Sequence
  Synthetic oligonucleotide
aagatagaaagaggacagttgttgg

SEQ ID NO: 192 - DNA, 25 bp, Artificial Sequence
  Synthetic oligonucleotide
gcctgctccagtggatccagcaacc

SEQ ID NO: 193 - DNA, 25 bp, Artificial Sequence
  Synthetic oligonucleotide
gcctggcaccattaaagaaaatatc

SEQ ID NO: 194 - DNA, 25 bp, Artificial Sequence
  Synthetic oligonucleotide
attcatcataggaaacaccaaagat

SEQ ID NO: 195 - DNA, 27 bp, Artificial Sequence
  Synthetic oligonucleotide
gcctggcaccattaaagaaaatatcat

SEQ ID NO: 196 - DNA, 25 bp, Artificial Sequence
  Synthetic oligonucleotide
ctatattcatcataggaaacaccaa

SEQ ID NO: 197 - DNA, 25 bp, Artificial Sequence
  Synthetic oligonucleotide
ctctaattttctatttttggtaata

SEQ ID NO: 198 - DNA, 25 bp, Artificial Sequence
  Synthetic oligonucleotide
ctttctctgcaaacttggagatgtc

SEQ ID NO: 199 - DNA, 25 bp, Artificial Sequence
  Synthetic oligonucleotide
tgcagagaaagacaatatagttctt

SEQ ID NO: 200 - DNA, 25 bp, Artificial Sequence
  Synthetic oligonucleotide
ccactcagtgtgattccaccttctc

SEQ ID NO: 201 - DNA, 25 bp, Artificial Sequence
  Synthetic oligonucleotide
gaaggtggaatcacactgagtggag

SEQ ID NO: 202 - DNA, 25 bp, Artificial Sequence
  Synthetic oligonucleotide
tgctaaagaaattcttgctcgttga

SEQ ID NO: 203 - DNA, 25 bp, Artificial Sequence
  Synthetic oligonucleotide
tggaatcacactgagtggaggtcaa

SEQ ID NO: 204 - DNA, 25 bp, Artificial Sequence
  Synthetic oligonucleotide
caccttgctaaagaaattcttgctc

SEQ ID NO: 205 - DNA, 25 bp, Artificial Sequence
  Synthetic oligonucleotide
caacgagcaagaatttctttagcaa

SEQ ID NO: 206 - DNA, 25 bp, Artificial Sequence
  Synthetic oligonucleotide
gctagaccaataattagttattcac

SEQ ID NO: 207 - DNA, 36 bp, Artificial Sequence
  Synthetic oligonucleotide
cctagatgttttaacagaaaaagaaatatttgaaag

SEQ ID NO: 208 - DNA, 25 bp, Artificial Sequence
  Synthetic oligonucleotide
ataagtaaggtattcaaagaacata

SEQ ID NO: 209 - DNA, 25 bp, Artificial Sequence
  Synthetic oligonucleotide
ctgtctcctggacagaaacaaaaaa

SEQ ID NO: 210 - DNA, 26 bp, Artificial Sequence
  Synthetic oligonucleotide
ccagtctgtttaaaagattgtttttt

SEQ ID NO: 211 - DNA, 28 bp, Artificial Sequence
  Synthetic oligonucleotide
gctcctgtctcctggacagaaacaaaaa

SEQ ID NO: 212 - DNA, 28 bp, Artificial Sequence
  Synthetic oligonucleotide
caaactctccagtctgtttaaaagattg

SEQ ID NO: 213 - DNA, 25 bp, Artificial Sequence
  Synthetic oligonucleotide
ctctccagtctgtttaaaagattgt

SEQ ID NO: 214 - DNA, 25 bp, Artificial Sequence
  Synthetic oligonucleotide
tgtgctgtggctccttggaaagtga

SEQ ID NO: 215 - DNA, 25 bp, Artificial Sequence
  Synthetic oligonucleotide
aatctacacaataggacatggaata

SEQ ID NO: 216 - DNA, 25 bp, Artificial Sequence
  Synthetic oligonucleotide
tcttaccatatttgacttcatccag

SEQ ID NO: 217 - DNA, 25 bp, Artificial Sequence
  Synthetic oligonucleotide
acttaacggtacttatttttacata

SEQ ID NO: 218 - DNA, 25 bp, Artificial Sequence
  Synthetic oligonucleotide
tttatttcagatgcgatctgtgagc

SEQ ID NO: 219 - DNA, 25 bp, Artificial Sequence
  Synthetic oligonucleotide
ggcatgtcaatgaacttaaagactc

SEQ ID NO: 220 - DNA, 25 bp, Artificial Sequence
  Synthetic oligonucleotide
acatgccaacagaaggtaaacctac

SEQ ID NO: 221 - DNA, 25 bp, Artificial Sequence
  Synthetic oligonucleotide
attcttgtatggtttggttgacttg

SEQ ID NO: 222 - DNA, 25 bp, Artificial Sequence
  Synthetic oligonucleotide
tccatctgttgcagtattaaaatgg

SEQ ID NO: 223 - DNA, 25 bp, Artificial Sequence
  Synthetic oligonucleotide
catttcctttcagggtgtcttactc

SEQ ID NO: 224 - DNA, 25 bp, Artificial Sequence
  Synthetic oligonucleotide
gggattcaataactttgcaacagtg

SEQ ID NO: 225 - DNA, 25 bp, Artificial Sequence
  Synthetic oligonucleotide
gtggtatcactccaaaggctttcct

SEQ ID NO: 226 - DNA, 25 bp, Artificial Sequence
  Synthetic oligonucleotide
cactccactgttcatagggatccaa